(19) United States
(12) Patent Application Publication
(10) Pub. No.: US 2026/0197448 A1
(43) Pub. Date: Jul. 9, 2026

(54) ENCODING METHOD, ENCODING DEVICE, DECODING METHOD, AND DECODING DEVICE FOR IMAGE

(71) Applicant: SAMSUNG ELECTRONICS CO., LTD., Suwon-si (KR)

(72) Inventors: Hyungmin ROH, Suwon-si (KR); Jeeyoon PARK, Suwon-si (KR)

(73) Assignee: SAMSUNG ELECTRONICS CO., LTD., Suwon-si (KR)

(21) Appl. No.: 19/552,730

(22) Filed: Feb. 27, 2026

Related U.S. Application Data
(63) Continuation of application No. PCT/KR2024/012148, filed on Aug. 14, 2024.

(30) Foreign Application Priority Data
Aug. 28, 2023 (KR) 10-2023-0113193
Jan. 15, 2024 (KR) 10-2024-0006299

(51) Int. Cl. H04N 19/117; H04N 19/107; H04N 19/176; H04N 19/186

(52) U.S. Cl. CPC H04N 19/117; H04N 19/107; H04N 19/176; H04N 19/186

(57) ABSTRACT

An image encoding method, an image encoding apparatus, an image decoding method, and an image decoding apparatus are provided. The image encoding method includes obtaining a current reconstructed block including a center sample, by using a prediction mode of a block, determining a plurality of differences between the center sample and a plurality of neighboring samples of the center sample, obtaining at least one lookup table (LUT) for filtering based on the prediction mode, determining a plurality of modifier values, based on the plurality of differences and the at least one LUT, determining at least one filtering parameter, based on a sum of the plurality of modifier values, determining an offset value, based on the at least one filtering parameter, and obtaining a filtered sample, based on the center sample and the offset value.

### CROSS-REFERENCE TO RELATED APPLICATIONS

This application is a continuation of International Application No. PCT/KR2024/012148, filed on Aug. 14, 2024, which is based on and claims priority to Korean Provisional Patent Application No. 10-2023-0113193 filed on Aug. 28, 2023, and Korean Patent Application No. 10-2024-0006299 filed on Jan. 15, 2024, in the Korean Intellectual Property Office, the disclosures of which are incorporated by reference herein in their entireties.

### BACKGROUND

### 1. Field

The present disclosure relates to the field of image encoding and decoding, and more particularly, to an apparatus and method for encoding and decoding an image by using filtering.

### 2. Description of Related Art

In encoding and decoding of an image, the image is split into blocks, and each block is prediction-encoded and prediction-decoded via inter prediction or intra prediction.

Inter prediction is a technique of compressing images by removing temporal redundancy between the images. In inter prediction, blocks of a current image are predicted using a reference image. A reference block that is most similar to a current block may be searched for within a certain search range in the reference image. The current block is predicted based on the reference block, and a prediction block generated as a result of prediction is subtracted from the current block to generate a residual block.

Intra prediction is a technique of compressing an image by removing spatial redundancy within the image. In intra prediction, a prediction block is generated based on neighboring pixels of a current block according to a prediction mode. In addition, a residual block is generated by subtracting the prediction block from the current block

The residual block generated through inter prediction or intra prediction is transformed and quantized and then transmitted to the decoder. The decoder inversely quantizes and inversely transforms the residual block and reconstructs the current block by combining the prediction block of the current block with the residual block. The decoder may remove an artifact in the reconstructed current block by filtering the reconstructed current block.

### SUMMARY

According to an aspect of the present disclosure, an image decoding method may include obtaining a current reconstructed block including a center sample, by using a prediction mode of a block; determining a plurality of differences between the center sample and a plurality of neighboring samples of the center sample; obtaining at least one lookup table (LUT) for filtering based on the prediction mode; determining a plurality of modifier values, based on the plurality of differences and the at least one LUT; determining at least one filtering parameter, based on a sum of the plurality of modifier values; determining an offset value, based on the at least one filtering parameter; and obtaining a filtered sample, based on the center sample and the offset value.

According to an aspect of the present disclosure, an image encoding method may include obtaining a current reconstructed block including a center sample, by using a prediction mode of a block; determining a plurality of differences between the center sample and a plurality of neighboring samples of the center sample; obtaining at least one LUT for filtering based on the prediction mode; determining a plurality of modifier values, based on the plurality of differences and the at least one LUT; determining at least one filtering parameter, based on a sum of the plurality of modifier values; determining an offset value, based on the at least one filtering parameter; and obtaining a filtered sample, based on the center sample and the offset value.

According to an aspect of the present disclosure, a computer-readable storage medium has stored therein at least one of a bitstream encoded by the image encoding method or a bitstream decoded by an image decoding apparatus.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an image decoding apparatus according to an embodiment of the present disclosure.

FIG. 2 is a block diagram of an image encoding apparatus according to an embodiment of the present disclosure;

FIG. 3 illustrates a process of determining at least one coding unit by splitting a current coding unit, according to an embodiment of the present disclosure;

FIG. 4 illustrates a process of determining at least one coding unit by splitting a non-square coding unit, according to an embodiment of the present disclosure;

FIG. 5 illustrates a process of splitting a coding unit based on at least one of block shape information or split shape mode information, according to an embodiment of the present disclosure;

FIG. 6 illustrates a method of determining a certain coding unit from among an odd number of coding units, according to an embodiment of the present disclosure;

FIG. 7 illustrates an order of processing a plurality of coding units when the plurality of coding units are determined by splitting a current coding unit, according to an embodiment of the present disclosure;

FIG. 8 illustrates a process of determining that a current coding unit is to be split into an odd number of coding units, when the coding units are not processable in a certain order, according to an embodiment of the present disclosure;

FIG. 9 illustrates a process of determining at least one coding unit by splitting a first coding unit, according to an embodiment of the present disclosure;

FIG. 10 illustrates that a shape into which a second coding unit is splittable is restricted when the second coding unit having a non-square shape, which is determined by splitting a first coding unit, satisfies a certain condition, according to an embodiment;

FIG. 11 illustrates a process of splitting a square coding unit when split shape mode information is unable to indicate that the square coding unit is split into four square coding units, according to an embodiment of the present disclosure;

FIG. 12 illustrates that a processing order between a plurality of coding units may be changed depending on a process of splitting a coding unit, according to an embodiment of the present disclosure;

FIG. 13 illustrates a process of determining a depth of a coding unit as a shape and size of the coding unit change, when the coding unit is recursively split such that a plurality of coding units are determined, according to an embodiment of the present disclosure;

FIG. 14 illustrates depths that are determinable based on shapes and sizes of coding units, and part indexes (PIDs) that are for distinguishing the coding units, according to an embodiment of the present disclosure;

FIG. 15 illustrates that a plurality of coding units are determined based on a plurality of certain data units included in a picture, according to an embodiment of the present disclosure;

FIG. 16 illustrates coding units which may be determined for each picture, when a combination of shapes into which a coding unit may be split is different for each picture, according to an embodiment of the present disclosure;

FIG. 17 illustrates various shapes of a coding unit, which may be determined based on split shape mode information expressed as a binary code, according to an embodiment of the present disclosure;

FIG. 18 illustrates another shape of a coding unit, which may be determined based on split shape mode information expressed as a binary code, according to an embodiment of the present disclosure;

FIG. 19 illustrates a block diagram of an image encoding and decoding system performing loop filtering according to an embodiment of the present disclosure;

FIG. 20 is a block diagram illustrating components of an image decoding apparatus according to an embodiment of the present disclosure;

FIG. 21 is a block diagram illustrating components of a loop filtering unit according to an embodiment of the present disclosure;

FIG. 22 is a diagram for describing a shape of a bilateral filter (BIF) according to an embodiment of the present disclosure;

FIG. 23 is a flowchart illustrating an image decoding method according to an embodiment of the present disclosure;

FIG. 24 is a diagram for describing filtering when a prediction mode indicates a combined inter intra prediction (CIIP) mode, according to an embodiment of the present disclosure;

FIG. 25 is a diagram for describing filtering when a prediction mode indicates a geometric partitioning mode (GPM), according to an embodiment of the present disclosure;

FIG. 26 is a diagram for describing filtering when a prediction mode indicates an intra block copy (IBC) mode, according to an embodiment of the present disclosure;

FIG. 27 is a diagram for describing filtering when a prediction mode indicates a template matching prediction mode, according to an embodiment of the present disclosure;

FIG. 28 is a block diagram illustrating components of a loop filtering unit according to an embodiment of the present disclosure;

FIG. 29 is a flowchart illustrating an image decoding method according to an embodiment of the present disclosure;

FIG. 30 is a diagram for describing a chroma BIF according to an embodiment of the present disclosure;

FIG. 31 is a diagram for describing a chroma BIF according to an embodiment of the present disclosure;

FIG. 32 is a diagram for describing a chroma BIF according to an embodiment of the present disclosure;

FIG. 33 is a diagram for describing a chroma BIF according to an embodiment of the present disclosure;

FIG. 34 is a block diagram illustrating components of an image encoding apparatus according to an embodiment of the present disclosure; and

FIG. 35 is a flowchart illustrating an image encoding method according to an embodiment of the present disclosure.

### DETAILED DESCRIPTION

As the present disclosure allows for various changes and numerous embodiments, particular embodiments will be shown in the drawings and described in detail in the written description. However, this is not intended to limit the present disclosure to particular modes of practice, and it is to be appreciated that all changes, equivalents, and substitutes that do not depart from the spirit and technical scope of the disclosure are encompassed in the present disclosure.

In the description of embodiments, certain detailed explanations of the related art are not provided here when it is deemed that they may unnecessarily obscure the essence of the present disclosure e. In addition, while such terms as “first,” “second,” etc., may be used to describe various components, such components must not be limited to the above terms. The above terms are used only to distinguish one component from another.

In the present disclosure, the expression “at least one of a, b or c” may indicate “a,” “b,” “c,” “a and b,” “a and c,” “b and c,” or “all of a, b, and c.”

In the present disclosure, when an element (e.g., a first element) is “coupled to” or “connected to” another element (e.g., a second element), the first element may be directly coupled to or connected to the second element, or, unless otherwise described, a third element may exist therebetween.

In the present disclosure, regarding a component expressed as a “portion (unit)” or a “module” used herein, two or more components may be combined into one component or one component may be divided into two or more components according to subdivided functions. In addition, each component described hereinafter may additionally perform some or all of functions performed by another component, in addition to main functions of itself, and some of the main functions of each component may be performed entirely by another component.

In the present disclosure, an “image” may include a picture, a still image, a frame, a moving image including a plurality of consecutive still images, or a video.

In the present disclosure, “a sample” may refer to data assigned to a sampling location of an image and may include data to be processed. For example, a sample may include a pixel in a frame of a spatial domain. A block may denote a unit including a plurality of samples.

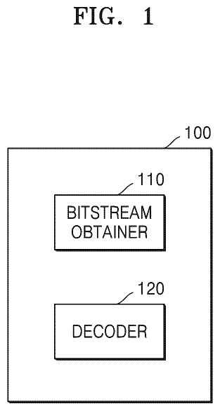

Hereinafter, image encoding method and apparatus and image decoding method and apparatus based on a coding unit and a transform unit of a tree structure according to an embodiment of the present disclosure are described with reference to FIGS. 1 through 35.

FIG. 1 is a block diagram of an image decoding apparatus 100 according to an embodiment of the present disclosure.

The image decoding apparatus 100 may include a bitstream obtainer 110 and a decoder 120. The bitstream obtainer 110 and the decoder 120 may include at least one processor. In addition, the bitstream obtainer 110 and the decoder 120 may include memory storing instructions to be performed by the at least one processor.

The bitstream obtainer 110 may receive a bitstream. The bitstream includes information about image encoding of an image encoding apparatus 200 described below. In addition, the bitstream may be transmitted from the image encoding apparatus 200. The image encoding apparatus 200 and the image decoding apparatus 100 may be connected by wire or wirelessly, and the bitstream obtainer 110 may receive the bitstream by wire or wirelessly. The bitstream obtainer 110 may receive the bitstream from a storage medium, such as an optical medium or a hard disk. The decoder 120 may reconstruct an image based on information obtained from the received bitstream. The decoder 120 may obtain, from the bitstream, a syntax element for reconstructing the image. The decoder 120 may reconstruct the image based on the syntax element.

To describe, in detail, an operation of the image decoding apparatus 100, the bitstream obtainer 110 may receive the bitstream.

The image decoding apparatus 100 may perform an operation of obtaining, from the bitstream, a bin string corresponding to a split shape mode of a coding unit. In addition, the image decoding apparatus 100 may perform an operation of determining a split rule of the coding unit. In addition, the image decoding apparatus 100 may perform an operation of splitting the coding unit into a plurality of coding units, based on at least one of the bin string corresponding to the split shape mode or the split rule. The image decoding apparatus 100 may determine an allowable first range of a size of the coding unit, according to a ratio of height to width of the coding unit, so as to determine the split rule. The image decoding apparatus 100 may determine an allowable second range of the size of the coding unit, according to the split shape mode of the coding unit, so as to determine the split rule.

Hereinafter, splitting of a coding unit will be described in detail according to an embodiment of the present disclosure.

First, one picture may be split into one or more slices or one or more tiles. One slice or one tile may be a sequence of one or more largest coding units (coding tree units (CTUs)). According to an implementation example, one slice may include one or more tiles, and one slice may include one or more CTUs. The slice including one tile or a plurality of tiles may be determined in the picture

A largest coding block (coding tree block (CTB)) is conceptually compared to a largest coding unit (CTU). The largest coding block (CTB) indicates an N×N block including N×N samples (N is an integer). Each color component may be split into one or more largest coding blocks.

A largest coding unit (CTU) of a case where a picture includes three sample arrays (sample arrays for Y, Cr, and Cb components) is a unit including a largest coding block of a luma sample, two corresponding largest coding blocks of chroma samples, and syntax structures used to encode the luma sample and the chroma samples. A largest coding unit of a case where a picture is a monochrome picture is a unit including a largest coding block of a monochrome sample and syntax structures used to encode monochrome samples. A largest coding unit of a case where a picture is a picture encoded in color planes separated according to color components is a unit including syntax structures used to encode the picture and samples of the picture.

One largest coding block (CTB) may be split into M×N coding blocks including M×N samples (M and N are integers).

A coding unit (CU) of a case where a picture has sample arrays for Y, Cr, and Cb components is a unit including a coding block of a luma sample, two corresponding coding blocks of chroma samples, and syntax structures used to encode the luma sample and the chroma samples. A coding unit of a case where a picture is a monochrome picture is a unit including a coding block of a monochrome sample and syntax structures used to encode the monochrome samples. A coding unit of a case where a picture is a picture encoded in color planes separated according to color components is a unit including syntax structures used to encode the picture and samples of the picture.

As described above, a largest coding block and a largest coding unit are conceptually distinguished from each other, and a coding block and a coding unit are conceptually distinguished from each other. That is, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a certain size including a certain number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, the present disclosure is not limited thereto.

For example, information about a maximum size of a luma coding block may be obtained from a bitstream. For example, the maximum size of the luma coding block indicated by the information about the maximum size of the luma coding block may be one of 4×4, 8×8, 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to an embodiment, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum of the luma coding block that is ternary splittable in an I-picture may be 32×32, and the maximum of the luma coding block that is ternary splittable in a P-picture or a B-picture may be 64×64.

In addition, a largest coding unit may be hierarchically split into coding units based on split shape mode information obtained from a bitstream. At least one of information indicating whether to perform quad splitting, information indicating whether to perform multi-splitting, split direction information, or split type information may be obtained as the split shape mode information from the bitstream.

For example, the information indicating whether to perform quad splitting may indicate whether a current coding unit is to be quad split (QUAD_SPLIT) or not.

When the current coding unit is not quad split, the information indicating whether to perform multi-splitting may indicate whether the current coding unit is to be no longer split (NO_SPLIT) or to be binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode SPLIT_TT_VER.

The image decoding apparatus 100 may obtain, from the bitstream, one bin string of the split shape mode information. A form of the bitstream received by the image decoding apparatus 100 may include fixed length binary code, unary code, truncated unary code, pre-determined binary code, etc. The bin string is information in a binary number. The bin string may include at least one bit. The image decoding apparatus 100 may obtain the split shape mode information corresponding to the bin string, based on the split rule. The image decoding apparatus 100 may determine whether to quad-split a coding unit, whether not to split a coding unit, a split direction, and a split type, based on one bin string.

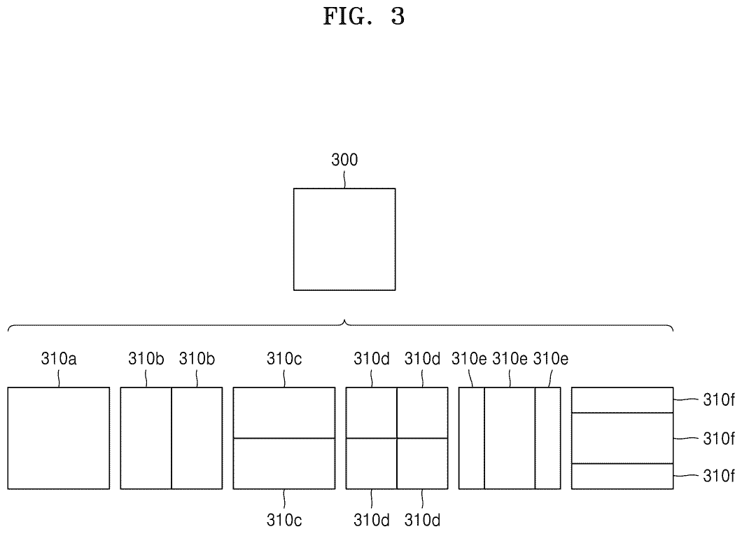

The coding unit may be smaller than or the same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape mode information about a largest coding unit indicates that splitting is performed, the largest coding unit may be split into coding units. In addition, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 to 16.

In addition, one or more prediction blocks for prediction may be determined from a coding unit. The prediction block may be the same as or smaller than the coding unit. In addition, one or more transform blocks for transformation may be determined from a coding unit. The transform block may be the same as or smaller than the coding unit.

The shapes and sizes of the transform block and prediction block may not be related to each other.

In another embodiment, prediction may be performed using a coding unit as a prediction unit. In addition, transformation may be performed using a coding unit as a transform block.

The splitting of the coding unit will be described in detail with reference to FIGS. 3 to 16. A current block and a neighboring block of the present disclosure may indicate one of the largest coding unit, the coding unit, the prediction block, and the transform block. In addition, the current block of the current coding unit is a block that is currently being decoded or encoded or a block that is currently being split. The neighboring block may be a block reconstructed before the current block. The neighboring block may be spatially or temporally adjacent to the current block. The neighboring block may be located at one of below left, left, above left, above, above right, right, and below right of the current block.

The embodiment described above relates to an operation related to the image decoding method performed by the image decoding apparatus 100. Hereinafter, an operation of the image encoding apparatus 200 performing an image encoding method, which corresponds to an inverse process of the image decoding method, is described according to an embodiment of the present disclosure.

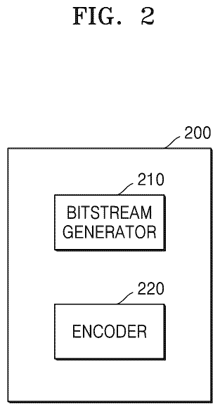

FIG. 2 is a block diagram of the image encoding apparatus 200 capable of encoding an image based on at least one of block shape information and split shape mode information, according to an embodiment of the present disclosure.

The image encoding apparatus 200 may include an encoder 220 and a bitstream generator 210. The encoder 220 may receive an input image and encode the input image. The encoder 220 may obtain at least one syntax element by encoding the input image. The syntax element may include at least one of a skip flag, a prediction mode, a motion vector difference, a motion vector prediction method (or index), a transform quantized coefficient, a coded block pattern, a coded block flag, an intra prediction mode, a direct flag, a merge flag, a delta QP, a reference index, a prediction direction, and a transform index. The encoder 220 may determine a context model based on the block shape information including at least one of a shape, a direction, a ratio between a width and a height, or a size of a coding unit.

The bitstream generator 210 may generate a bitstream based on the encoded input image. For example, the bitstream generator 210 may generate the bitstream by entropy encoding the syntax element based on the context model. In addition, the image encoding apparatus 200 may transmit the bitstream to the image decoding apparatus 100.

According to an embodiment of the present disclosure, the encoder 220 of the image encoding apparatus 200 may determine a shape of the coding unit. For example, the coding unit may have a square shape or a non-square shape, and information indicating the square shape or the non-square shape may be included in the block shape information.

According to an embodiment of the present disclosure, the encoder 220 may determine into which shape the coding unit is to be split. The encoder 220 may determine a shape of at least one coding unit included in the coding unit, and the bitstream generator 210 may generate the bitstream including the split shape mode information including information about the shape of the coding unit.

According to an embodiment of the present disclosure, the encoder 220 may determine whether or not to split the coding unit. When the encoder 220 determines that only one coding unit is included in the coding unit or the coding unit is not split, the bitstream generator 210 may generate the bitstream including the split shape mode information indicating that the coding unit is not split. In addition, the encoder 220 may split the coding unit into a plurality of coding units, and the bitstream generator 210 may generate the bitstream including the split shape mode information indicating that the coding unit is split into the plurality of coding units.

According to an embodiment of the present disclosure, information indicating into which number of coding units the coding unit is to be split or in which direction the coding unit is to be split may be included in the split shape mode information. For example, the split shape mode information may indicate to split the coding unit in at least one direction of a vertical direction and a horizontal direction or may indicate not to split the coding unit.

The image encoding apparatus 200 may determine information about a split shape mode, based on the split shape mode of the coding unit. The image encoding apparatus 200 may determine a context model based on at least one of a shape, a direction, a ratio between a width and a height, or a size of the coding unit. In addition, the image encoding apparatus 200 may generate the information about the split shape mode for splitting the coding unit as a bitstream based on the context model.

In order to determine the context model, the image encoding apparatus 200 may obtain an arrangement for making a correspondence between at least one of the shape, the direction, the ratio between the width and the height, or the size of the coding unit, and an index with respect to the context model. The image encoding apparatus 200 may obtain, from the arrangement, the index with respect to the context model based on at least one of the shape, the direction, the ratio between the width and the height, or the size of the coding unit. The image encoding apparatus 200 may determine the context model based on the index with respect to the context model.

In order to determine the context model, the image encoding apparatus 200 may determine the context model further based on block shape information including at least one of a shape, a direction, a ratio between a width and a height, or a size of a neighboring coding unit adjacent to the coding unit. In addition, the neighboring coding unit may include at least one of coding units located at below left, left, above left, above, above right, right, and below right of the coding unit.

In addition, the image encoding apparatus 200 may compare a width of the upper neighboring coding unit with a width of the coding unit, in order to determine the context model. In addition, the image encoding apparatus 200 may compare heights of the left and right neighboring coding units with a height of the coding unit. In addition, the image encoding apparatus 200 may determine the context model based on results of the comparison.

The operation of the image encoding apparatus 200 include similar aspects as the operation of the image decoding apparatus 100 described with reference to FIGS. 3 through 19, and thus, a detailed description thereof is not provided here.

FIG. 3 illustrates a process, performed by the image decoding apparatus 100, of determining at least one coding unit by splitting a current coding unit, according to an embodiment of the present disclosure.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a ratio of width to height, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information about the coding unit to be a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information about the coding unit to be a non-square shape. When the shape of the coding unit is non-square, the image decoding apparatus 100 may determine the ratio of width to height among the block shape information about the coding unit to be at least one of 1:2, 2:1, 1:4, 4:1, 1:8, 8:1, 1:16, 16:1, 1:32, or 32:1. In addition, the image decoding apparatus 100 may determine whether the coding unit is in a horizontal direction or a vertical direction, based on the length of the width and the length of the height of the coding unit. In addition, the image decoding apparatus 100 may determine the size of the coding unit, based on at least one of the length of the width, the length of the height, or the area of the coding unit.

According to an embodiment of the present disclosure, the image decoding apparatus 100 may determine the shape of the coding unit by using the block shape information, and may determine a split shape of the coding unit by using the split shape mode information. That is, a splitting method of the coding unit indicated by the split shape mode information may be determined based on a block shape indicated by the block shape information used by the image decoding apparatus 100.

The image decoding apparatus 100 may obtain the split shape mode information from a bitstream. However, an embodiment is not limited thereto, and the image decoding apparatus 100 and the image encoding apparatus 2200 may determine pre-agreed split shape mode information, based on the block shape information. The image decoding apparatus 100 may determine the pre-agreed split shape mode information with respect to a largest coding unit or a smallest coding unit. For example, the image decoding apparatus 100 may determine split shape mode information with respect to the largest coding unit to be a quad split. In addition, the image decoding apparatus 100 may determine split shape mode information regarding the smallest coding unit to be “no split”. In particular, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. In addition, the image decoding apparatus 100 may determine the size of the smallest coding unit to be 4×4. The image decoding apparatus 100 may obtain split shape mode information indicating “no split” with respect to the smallest coding unit.

According to an embodiment of the present disclosure, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information about a current coding unit 300 indicates a square shape, the decoder 120 may determine that a coding unit 310a having the same size as the current coding unit 300 is not split, based on the split shape mode information indicating no split, or may determine coding units 310b, 310c, 310d, 310e, 310f, etc. split based on the split shape mode information indicating a certain splitting method.

Referring to FIG. 3, according to an embodiment of the present disclosure, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to an embodiment of the present disclosure, the image decoding apparatus 100 may determine three coding units 310e obtained by splitting the current coding unit 300 in a vertical direction, based on the split shape mode information indicating to perform ternary-splitting in a vertical direction. The image decoding apparatus 100 may determine three coding units 310f obtained by splitting the current coding unit 300 in a horizontal direction, based on the split shape mode information indicating to perform ternary-splitting in a horizontal direction. However, splitting methods of the square coding unit are not limited to the above-described methods, and the split shape mode information may indicate various methods. Certain splitting methods of splitting the square coding unit will be described in detail below in an embodiment of the present disclosure.

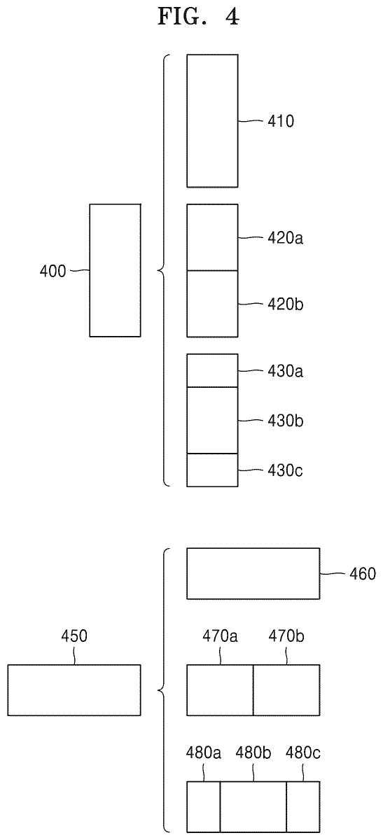

FIG. 4 illustrates a process, performed by the image decoding apparatus 100, of determining at least one coding unit by splitting a non-square coding unit, according to an embodiment of the present disclosure.

According to an embodiment of the present disclosure, the image decoding apparatus 100 may use block shape information indicating that a current coding unit has a non-square shape. The image decoding apparatus 100 may determine whether not to split the non-square current coding unit or whether to split the non-square current coding unit by using a certain splitting method, based on split shape mode information. Referring to FIG. 4, when the block shape information about a current coding unit 400 or 450 indicates a non-square shape, the image decoding apparatus 100 may determine that a coding unit 410 or 460 having the same size as the current coding unit 400 or 450 is not split, based on the split shape mode information indicating no split, or may determine coding units 420a, 420b, 430a, 430b, 430c, 470a, 470b, 480a, 480b, and 480c split based on the split shape mode information indicating a certain splitting method. Certain splitting methods of splitting a non-square coding unit will be described in detail below in an embodiment of the present disclosure.

According to an embodiment of the present disclosure, the image decoding apparatus 100 may determine a splitting method of a coding unit by using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to an embodiment of the present disclosure, when the image decoding apparatus 100 splits the non-square current coding unit 400 or 450 based on the split shape mode information, the image decoding apparatus 100 may consider the location of a long side of the non-square current coding unit 400 or 450 so as to split a current coding unit. For example, the image decoding apparatus 100 may determine a plurality of coding units by splitting the current coding unit 400 or 450 in a direction of splitting a long side of the current coding unit 400 or 450, in consideration of the shape of the current coding unit 400 or 450.

According to an embodiment of the present disclosure, when the split shape mode information indicates to split (ternary-split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment of the present disclosure, a ratio of height to width of the current coding unit 400 or 450 may be 4:1 or 1:4. When the ratio of height to width is 4:1, the block shape information may be a horizontal direction because the length of the width is longer than the length of the height. When the ratio of height to width is 1:4, the block shape information may be a vertical direction because the length of the width is shorter than the length of the height. The image decoding apparatus 100 may determine to split a current coding unit into the odd number of blocks, based on the split shape mode information. In addition, the image decoding apparatus 100 may determine a split direction of the current coding unit 400 or 450, based on the block shape information about the current coding unit 400 or 450. For example, when the current coding unit 400 is in the vertical direction, the image decoding apparatus 100 may determine the coding units 430a, 430b, and 430c by splitting the current coding unit 400 in the horizontal direction. In addition, when the current coding unit 450 is in the horizontal direction, the image decoding apparatus 100 may determine the coding units 480a, 480b, and 480c by splitting the current coding unit 450 in the vertical direction.

According to an embodiment of the present disclosure, the image decoding apparatus 100 may determine the odd number of coding units included in the current coding unit 400 or 450, and not all the determined coding units may have the same size. For example, a certain coding unit 430b or 480b from among the determined odd number of coding units 430a, 430b, and 430c, or 480a, 480b, and 480c may have a size different from the size of the other coding units 430a and 430c, or 480a and 480c. That is, coding units that may be determined by splitting the current coding unit 400 or 450 may have a plurality of sizes and, in some cases, all of the odd number of coding units 430a, 430b, and 430c, or 480a, 480b, and 480c may have different sizes.

According to an embodiment of the present disclosure, when the split shape mode information indicates to split a coding unit into the odd number of blocks, the image decoding apparatus 100 may determine the odd number of coding units included in the current coding unit 400 or 450, and further, may put a certain restriction on at least one coding unit from among the odd number of coding units generated by splitting the current coding unit 400 or 450. Referring to FIG. 4, the image decoding apparatus 100 may set a decoding process regarding the coding unit 430b or 480b to be different from that of the other coding units 430a and 430c, or 480a or 480c, the coding unit 430b or 480b being located at the center among the three coding units 430a, 430b, and 430c or 480a, 480b, and 480c generated as the current coding unit 400 or 450 is split. For example, the image decoding apparatus 100 may restrict the coding unit 430b or 480b at the center location to be no longer split or to be split only a certain number of times, unlike the other coding units 430a and 430c, or 480a and 480c.

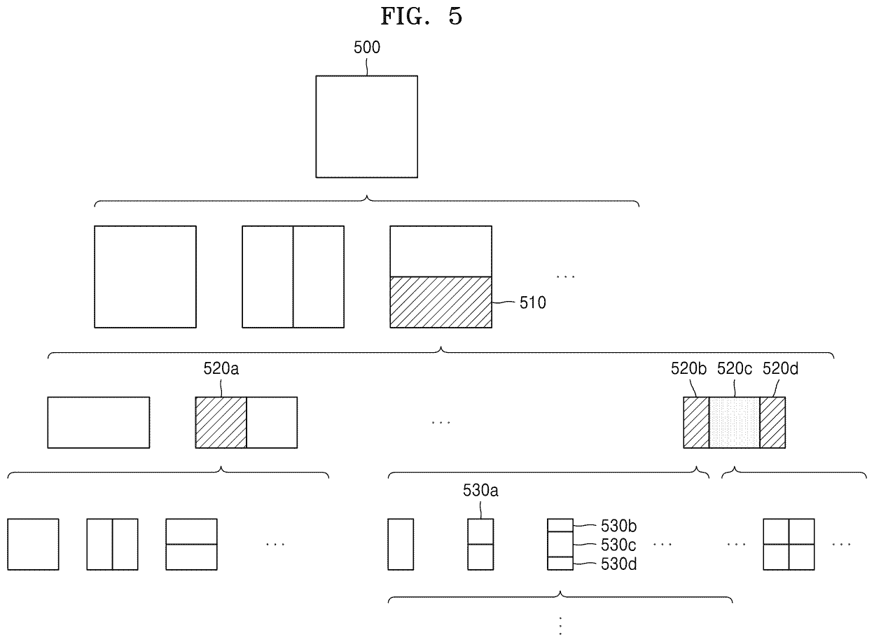

FIG. 5 illustrates a process, performed by the image decoding apparatus 100, of splitting a coding unit based on at least one of block shape information or split shape mode information, according to an embodiment of the present disclosure.

According to an embodiment of the present disclosure, the image decoding apparatus 100 may determine to split or not to split a square first coding unit 500 into coding units, based on at least one of the block shape information or the split shape mode information. According to an embodiment of the present disclosure, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment of the present disclosure are terms used to understand a relation before and after a coding unit is split. For example, a second coding unit may be determined by splitting a first coding unit, and a third coding unit may be determined by splitting the second coding unit. Hereinafter, it will be understood that the structure of the first coding unit, the second coding unit, and the third coding unit follows the above descriptions.

According to an embodiment of the present disclosure, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, 520b, 520c, and 520d based on the split shape mode information. The image decoding apparatus 100 may obtain the split shape mode information, and may obtain a plurality of various-shaped second coding units (e.g., the second coding unit 510) by splitting the first coding unit 500, based on the obtained split shape mode information, and the second coding unit 510 may be split using a splitting method of the first coding unit 500 based on the split shape mode information. According to an embodiment of the present disclosure, when the first coding unit 500 is split into the second coding units 510 based on the split shape mode information about the first coding unit 500, the second coding unit 510 may also be split into the third coding units (e.g., 520a, 520b, 520c, and 520d) based on the split shape mode information about the second coding unit 510. That is, a coding unit may be recursively split based on the split shape mode information about each coding unit. Therefore, a square coding unit may be determined by splitting a non-square coding unit, and a non-square coding unit may be determined by recursively splitting the square coding unit.

Referring to FIG. 5, a certain coding unit from among the odd number of third coding units 520b, 520c, and 520d determined by splitting the non-square second coding unit 510 (e.g., a coding unit at a center location or a square coding unit) may be recursively split. According to an embodiment of the present disclosure, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in an embodiment of the present disclosure.

According to an embodiment of the present disclosure, the image decoding apparatus 100 may split each of the third coding units 520a, or 520b, 520c, and 520d into coding units, based on the split shape mode information. In addition, the image decoding apparatus 100 may determine not to split the second coding unit 510 based on the split shape mode information. According to an embodiment of the present disclosure, the image decoding apparatus 100 may split the non-square second coding unit 510 into the odd number of third coding units 520b, 520c, and 520d. The image decoding apparatus 100 may put a certain restriction on a certain third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split using a certain splitting method (e.g., split into only four coding units or split using a splitting method of the second coding unit 510), or to be split only a certain number of times (e.g., split only n times (where n>0)). However, the restrictions on the third coding unit 520c at the center location are not limited to the above-described embodiments, and may include various restrictions for decoding the third coding unit 520c at the center location differently from the other third coding units 520b and 520d.

According to an embodiment of the present disclosure, the image decoding apparatus 100 may obtain the split shape mode information, which is used to split a current coding unit, from a certain location in the current coding unit.

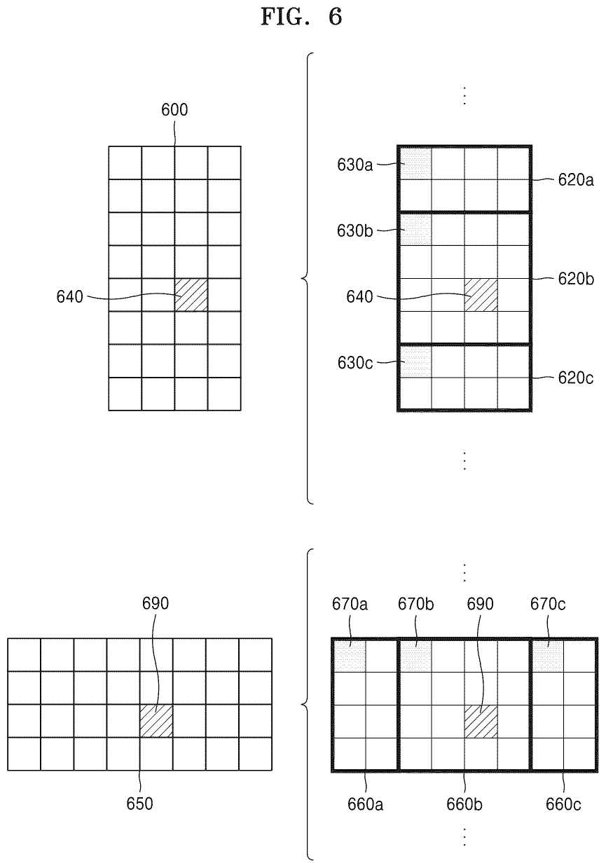

FIG. 6 illustrates a method, performed by the image decoding apparatus 100, of determining a certain coding unit from among an odd number of coding units, according to an embodiment of the present disclosure.

Referring to FIG. 6, split shape mode information about a current coding unit 600 or 650 may be obtained from a sample of a certain location (e.g., a sample 640 or 690 of a center location) from among a plurality of samples included in the current coding unit 600 or 650. However, the certain location in the current coding unit 600, from which at least one piece of the split shape mode information may be obtained, is not limited to the center location in FIG. 6, and may include various locations (e.g., top, bottom, left, right, upper left, lower left, upper right, and lower right locations) included in the current coding unit 600. The image decoding apparatus 100 may obtain the split shape mode information from the certain location and may determine to split or not to split the current coding unit into various-shaped and various-sized coding units.

According to an embodiment of the present disclosure, when the current coding unit is split into a certain number of coding units, the image decoding apparatus 100 may select one of the coding units. Various methods may be used to select one of a plurality of coding units, and will be described below in an embodiment of the present disclosure.

According to an embodiment of the present disclosure, the image decoding apparatus 100 may split the current coding unit into a plurality of coding units, and may determine a coding unit at a certain location.

According to an embodiment of the present disclosure, image decoding apparatus 100 may use information indicating locations of the odd number of coding units so as to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of certain samples included in the coding units 620a, 620b, and 620c. Specifically, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment of the present disclosure, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment of the present disclosure, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to differences between the coordinates.

According to an embodiment of the present disclosure, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or furthermore may use coordinates (dxb, dyb) indicating a relative location of the upper left sample 630b of the middle coding unit 620b and coordinates (dxc, dyc) indicating a relative location of the upper left sample 630c of the lower coding unit 620c with respect to the location of the upper left sample 630a of the upper coding unit 620a. A method of determining a coding unit at a certain location by using coordinates of a sample included in the coding unit, as information indicating a location of the sample, is not limited to the above-described method, and may include various arithmetic methods of using the coordinates of the sample.

According to an embodiment of the present disclosure, the image decoding apparatus 100 may split the current coding unit 600 into the plurality of coding units 620a, 620b, and 620c, and may select one of the coding units 620a, 620b, and 620c based on a certain criterion. For example, the image decoding apparatus 100 may select the coding unit 620b that has a size different from that of the others, from among the coding units 620a, 620b, and 620c.

According to an embodiment of the present disclosure, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment of the present disclosure, the image decoding apparatus 100 may determine the width of the upper coding unit 620a to be the width of the current coding unit 600. The image decoding apparatus 100 may determine the height of the upper coding unit 620a to be yb-ya. According to an embodiment of the present disclosure, the image decoding apparatus 100 may determine the width of the middle coding unit 620b to be the width of the current coding unit 600. The image decoding apparatus 100 may determine the height of the middle coding unit 620b to be yc-yb. According to an embodiment of the present disclosure, the image decoding apparatus 100 may determine the width or height of the lower coding unit by using the width or height of the current coding unit or the widths or heights of the upper coding unit 620a and the middle coding unit 620b. The image decoding apparatus 100 may determine a coding unit having a size different from those of the other coding units, based on the determined widths and heights of the coding units 620a, 620b, and 620c. Referring to FIG. 6, the image decoding apparatus 100 may determine the middle coding unit 620b having a size different from the sizes of the upper coding unit 620a and the lower coding unit 620c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units that are determined based on coordinates of samples, and thus, various methods of determining a coding unit at a certain location by comparing the sizes of coding units that are determined based on coordinates of certain samples may be used.

The image decoding apparatus 100 may determine the width or height of each of the coding units 660a, 660b, and 660c by using the coordinates (xd, yd) that is information indicating the location of an upper left sample 670a of the left coding unit 660a, the coordinates (xe, ye) that is information indicating the location of an upper left sample 670b of the middle coding unit 660b, and the coordinates (xf, yf) that is information indicating a location of an upper left sample 670c of the right coding unit 660c. The image decoding apparatus 100 may determine the respective sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a to be the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600. According to an embodiment of the present disclosure, the image decoding apparatus 100 may determine the width or height of the right coding unit 660c by using the width or height of the current coding unit 650 or the widths or heights of the left coding unit 660a and the middle coding unit 660b. The image decoding apparatus 100 may determine a coding unit that has a size different from that of the others, based on the determined widths and heights of the coding units 660a, 660b, and 660c. Referring to FIG. 6, the image decoding apparatus 100 may determine the middle coding unit 660b having a size different from the sizes of the left coding unit 660a and the right coding unit 660c, as the coding unit of the certain location. However, the above-described method, performed by the image decoding apparatus 100, of determining a coding unit having a size different from the size of the other coding units merely corresponds to an example of determining a coding unit at a certain location by using the sizes of coding units that are determined based on coordinates of samples, and thus, various methods of determining a coding unit at a certain location by comparing the sizes of coding units that are determined based on coordinates of certain samples may be used.

However, locations of samples considered to determine locations of coding units are not limited to the above-described upper left locations, and information about arbitrary locations of samples included in the coding units may be used.

According to an embodiment of the present disclosure, the image decoding apparatus 100 may select a coding unit at a certain location from among an odd number of coding units determined by splitting the current coding unit, by considering the shape of the current coding unit. For example, when the current coding unit has a non-square shape, a width of which is longer than a height, the image decoding apparatus 100 may determine the coding unit at the certain location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the certain location in a vertical direction. That is, the image decoding apparatus 100 may determine one of coding units at different locations in a vertical direction and may put a restriction on the coding unit.

According to an embodiment of the present disclosure, the image decoding apparatus 100 may use information indicating respective locations of an even number of coding units so as to determine the coding unit at the certain location from among the even number of coding units. The image decoding apparatus 100 may determine an even number of coding units by splitting (binary-splitting) the current coding unit, and may determine the coding unit at the certain location by using the information about the locations of the even number of coding units. An operation related thereto may correspond to the operation of determining a coding unit at a certain location (e.g., a center location) from among an odd number of coding units, which has been described in detail above with reference to FIG. 6, and thus, detailed descriptions thereof are not provided here.

According to an embodiment of the present disclosure, when a non-square current coding unit is split into a plurality of coding units, certain information about a coding unit at a certain location may be used in a splitting operation to determine the coding unit at the certain location from among the plurality of coding units. For example, the image decoding apparatus 100 may use at least one of block shape information or split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information about the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment of the present disclosure, certain information for identifying the coding unit at the certain location may be obtained from a certain sample included in a coding unit to be determined. Referring to FIG. 6, the image decoding apparatus 100 may use the split shape mode information that is obtained from a sample at a certain location in the current coding unit 600 (e.g., a sample at a center location of the current coding unit 600) to determine a coding unit at a certain location from among the plurality of the coding units 620a, 620b, and 620c determined by splitting the current coding unit 600 (e.g., a coding unit at a center location from among a plurality of split coding units). That is, the image decoding apparatus 100 may determine the sample at the certain location by considering a block shape of the current coding unit 600, may determine the coding unit 620b including a sample, from which certain information (e.g., the split shape mode information) may be obtained, from among the plurality of coding units 620a, 620b, and 620c determined by splitting the current coding unit 600, and may put a certain restriction on the coding unit 620b. Referring to FIG. 6, according to an embodiment of the present disclosure, the image decoding apparatus 100 may determine the sample 640 at the center location of the current coding unit 600 as the sample from which the certain information may be obtained, and may put a certain restriction on the coding unit 620b including the sample 640, in a decoding operation. However, the location of the sample from which the certain information may be obtained is not limited to the above-described location, and may include arbitrary locations of samples included in the coding unit 620b to be determined for a restriction.

According to an embodiment of the present disclosure, the location of the sample from which the certain information may be obtained may be determined based on the shape of the current coding unit 600. According to an embodiment of the present disclosure, the block shape information may indicate whether the current coding unit has a square or non-square shape, and the location of the sample from which the certain information may be obtained may be determined based on the shape. For example, the image decoding apparatus 100 may determine a sample located on a boundary for splitting at least one of a width or height of the current coding unit in half, as the sample from which the certain information may be obtained, by using at least one of information about the width of the current coding unit or information about the height of the current coding unit. As another example, when the block shape information about the current coding unit indicates a non-square shape, the image decoding apparatus 100 may determine one of samples adjacent to a boundary for splitting a long side of the current coding unit in half, as the sample from which the certain information may be obtained.

According to an embodiment of the present disclosure, when the current coding unit is split into a plurality of coding units, the image decoding apparatus 100 may use the split shape mode information so as to determine a coding unit at a certain location from among the plurality of coding units. According to an embodiment of the present disclosure, the image decoding apparatus 100 may obtain the split shape mode information from a sample at a certain location in a coding unit, and may split the plurality of coding units, which are generated by splitting the current coding unit, by using the split shape mode information, which is obtained from the sample of the certain location in each of the plurality of coding units. That is, a coding unit may be recursively split based on the split shape mode information that is obtained from the sample at the certain location in each coding unit. An operation of recursively splitting a coding unit has been described above with reference to FIG. 5, and thus, detailed descriptions thereof are not provided here.

According to an embodiment of the present disclosure, the image decoding apparatus 100 may determine one or more coding units by splitting the current coding unit, and may determine an order of decoding the one or more coding units, based on a certain block (e.g., the current coding unit).

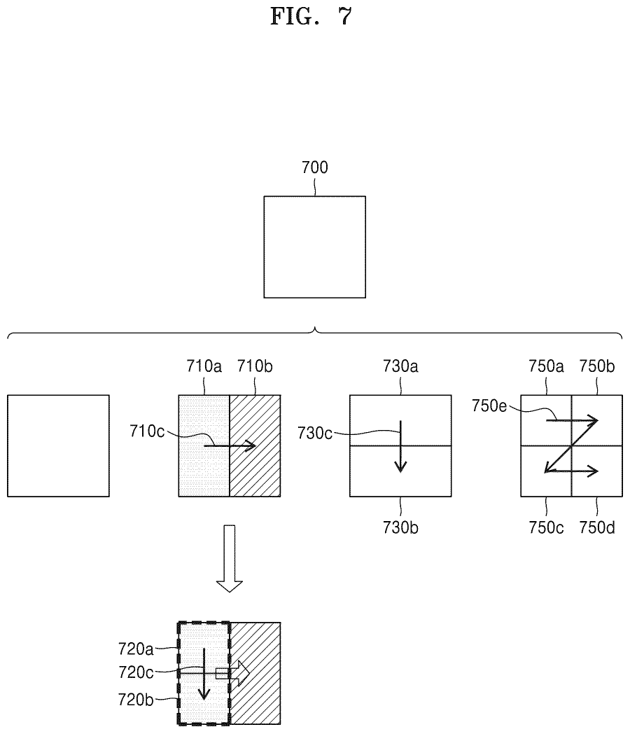

FIG. 7 illustrates an order of processing a plurality of coding units when the image decoding apparatus 100 determines the plurality of coding units by splitting a current coding unit, according to an embodiment of the present disclosure.

According to an embodiment of the present disclosure, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b that are determined by splitting the first coding unit 700 in a vertical direction, in a horizontal direction 710c. The image decoding apparatus 100 may determine to process the second coding units 730a and 730b that are determined by splitting the first coding unit 700 in a horizontal direction, in a vertical direction 730c. The image decoding apparatus 100 may determine to process the second coding units 750a, 750b, 750c, and 750d, which are determined by splitting the first coding unit 700 in vertical and horizontal directions, in a certain order 750e (e.g., in a raster scan order or Z-scan order) for processing coding units in a row and then processing coding units in a next row.

According to an embodiment of the present disclosure, the image decoding apparatus 100 may recursively split coding units. Referring to FIG. 7, the image decoding apparatus 100 may determine the plurality of coding units 710a, 710b, 730a, 730b, 750a, 750b, 750c, and 750d by splitting the first coding unit 700, and may recursively split each of the determined plurality of coding units 710a, 710b, 730a, 730b, 750a, 750b, 750c, and 750d. A splitting method of the plurality of coding units 710a, 710b, 730a, 730b, 750a, 750b, 750c, and 750d may correspond to a splitting method of the first coding unit 700. Accordingly, each of the plurality of coding units 710a, 710b, 730a, 730b, 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment of the present disclosure, the image decoding apparatus 100 may determine third coding units 720a and 720b by splitting the left second coding unit 710a in a horizontal direction, and may not split the right second coding unit 710b.

According to an embodiment of the present disclosure, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction 720c. Because the left second coding unit 710a and the right second coding unit 710b are processed in the horizontal direction 710c, the right second coding unit 710b may be processed after the third coding units 720a and 720b included in the left second coding unit 710a are processed in the vertical direction 720c. A process of determining a processing order of coding units based on a coding unit before being split is described above and not limited to the above-described example, and it should be understood that various methods may be used to independently process coding units that are split into and determined to various shapes, in a certain order.

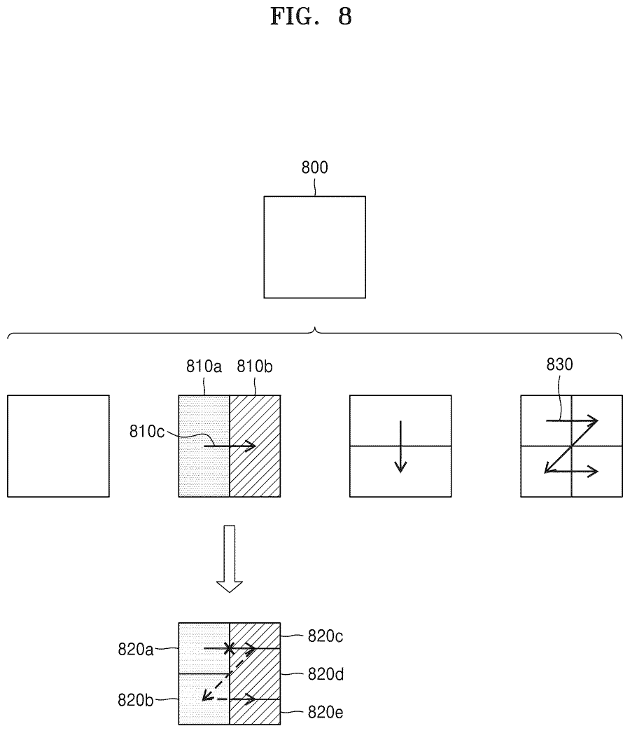

FIG. 8 illustrates a process, performed by the image decoding apparatus 100, of determining that a current coding unit is to be split into an odd number of coding units, when the coding units are not processable in a certain order, according to an embodiment of the present disclosure.

According to an embodiment of the present disclosure, the image decoding apparatus 100 may determine whether the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c, 820d and 820e. According to an embodiment of the present disclosure, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment of the present disclosure, the image decoding apparatus 100 may determine whether there is any coding unit being split into an odd number of coding units, by determining whether the third coding units 820a and 820b, and 820c, 820d and 820e are processable in a certain order. Referring to FIG. 8, the image decoding apparatus 100 may determine the third coding units 820a and 820b, and 820c, 820d and 820e by recursively splitting the first coding unit 800. The image decoding apparatus 100 may determine whether any of the first coding unit 800, the second coding units 810a and 810b, and the third coding units 820a and 820b, and 820c, 820d and 820e are split into an odd number of coding units, based on at least one of the block shape information or the split shape mode information. For example, the right second coding unit 810b among the second coding units 810a and 810b may be split into an odd number of third coding units 820c, 820d, and 820e. A processing order of a plurality of coding units included in the first coding unit 800 may be a certain order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the certain order.

According to an embodiment of the present disclosure, the image decoding apparatus 100 may determine whether the third coding units 820a and 820b, and 820c, 820d and 820e included in the first coding unit 800 satisfy the condition for processing in the certain order, and the condition relates to whether at least one of widths or heights of the second coding units 810a and 810b is split in half along a boundary of the third coding units 820a and 820b, and 820c, 820d and 820e. For example, the third coding units 820a and 820b that are determined when the height of the left second coding unit 810a of the non-square shape is split in half may satisfy the condition. The image decoding apparatus 100 may determine that the third coding units 820c, 820d, and 820e do not satisfy the condition because the boundaries of the third coding units 820c, 820d, and 820e that are determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment of the present disclosure, when a coding unit is split into an odd number of coding units, the image decoding apparatus 100 may put a certain restriction on a coding unit at a certain location from among the split coding units, and the restriction or the certain location is described above according to an embodiment of the present disclosure, and thus, detailed descriptions thereof are not provided here.

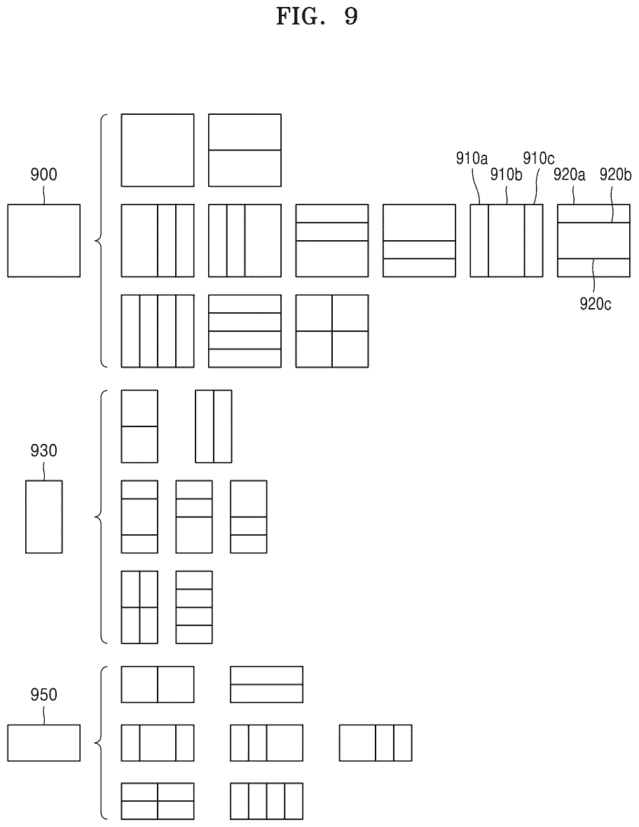

FIG. 9 illustrates a process, performed by the image decoding apparatus 100, of determining at least one coding unit by splitting a first coding unit 900, according to an embodiment of the present disclosure.

According to an embodiment of the present disclosure, the image decoding apparatus 100 may split the first coding unit 900, based on split shape mode information obtained through the bitstream obtainer 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. Specifically, when the split shape mode information indicates to determine an odd number of coding units by splitting the first coding unit 900 in a horizontal direction or a vertical direction, the image decoding apparatus 100 may split the square first coding unit 900 into an odd number of coding units that are second coding units 910a, 910b, and 910c determined by splitting the square first coding unit 900 in a vertical direction or second coding units 920a, 920b, and 920c determined by splitting the square first coding unit 900 in a horizontal direction.

According to an embodiment of the present disclosure, the image decoding apparatus 100 may determine whether the second coding units 910a, 910b, 910c, 920a, 920b, and 920c included in the first coding unit 900 satisfy a condition for processing in a certain order, and the condition relates to whether at least one of a width or height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, the image decoding apparatus 100 may determine that the first coding unit 900 does not satisfy the condition for processing in the certain order. In addition, because boundaries of the second coding units 920a, 920b, and 920c determined by splitting the square first coding unit 900 in a horizontal direction do not split the height of the first coding unit 900 in half, the image decoding apparatus 100 may determine that the first coding unit 900 does not satisfy the condition for processing in the certain order. When the condition is not satisfied as described above, the image decoding apparatus 100 may determine disconnection of a scan order, and may determine that the first coding unit 900 is split into an odd number of coding units, based on a result of the determination. According to an embodiment of the present disclosure, when a coding unit is split into an odd number of coding units, the image decoding apparatus 100 may put a certain restriction on a coding unit at a certain location from among the split coding units, and the restriction or the certain location is described above according to an embodiment of the present disclosure, and thus, detailed descriptions thereof are not provided here.

According to an embodiment of the present disclosure, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

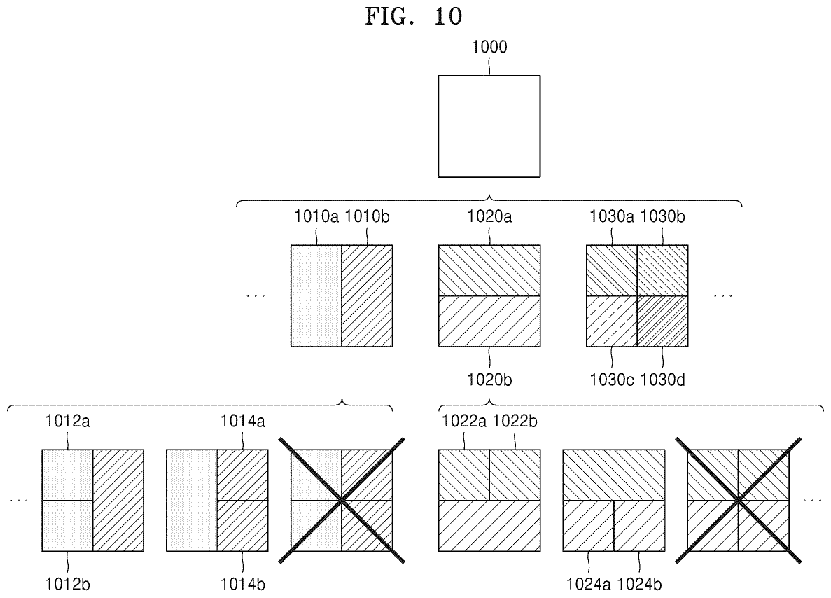

FIG. 10 illustrates that a shape into which a second coding unit is splittable is restricted when the second coding unit having a non-square shape, which is determined when an image decoding apparatus splits a first coding unit, satisfies a certain condition, according to an embodiment of the present disclosure.

According to an embodiment of the present disclosure, the image decoding apparatus 100 may determine to split a square first coding unit 1000 into non-square second coding units 1010a, 1010b, 1020a, and 1020b, based on split shape mode information obtained through the bitstream obtainer 110. The second coding units 1010a, 1010b, 1020a, and 1020b may be independently split. Accordingly, the image decoding apparatus 100 may determine to split or not to split each of the second coding units 1010a, 1010b, 1020a, and 1020b into a plurality of coding units, based on the split shape mode information about each of the second coding units 1010a, 1010b, 1020a, and 1020b. According to an embodiment of the present disclosure, the image decoding apparatus 100 may determine third coding units 1012a and 1012b by splitting the non-square left second coding unit 1010a that is determined by splitting the first coding unit 1000 in a vertical direction, in a horizontal direction. However, when the left second coding unit 1010a is split in a horizontal direction, the image decoding apparatus 100 may restrict the right second coding unit 1010b not to be split in a horizontal direction in which the left second coding unit 1010a is split. When third coding units 1014a and 1014b are determined by splitting the right second coding unit 1010b in the same direction, the left second coding unit 1010a and the right second coding unit 1010b are independently split in a horizontal direction such that the third coding units 1012a and 1012b or 1014a and 1014b may be determined. However, this has the same result as the image decoding apparatus 100 splitting the first coding unit 1000 into four square second coding units 1030a, 1030b, 1030c, and 1030d based on the split shape mode information, and may be inefficient in terms of image decoding.

According to an embodiment of the present disclosure, the image decoding apparatus 100 may determine third coding units 1022a and 1022b or 1024a and 1024b by splitting the non-square second coding unit 1020a or 1020b which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) not to be split in a vertical direction in which the upper second coding unit 1020a is split.

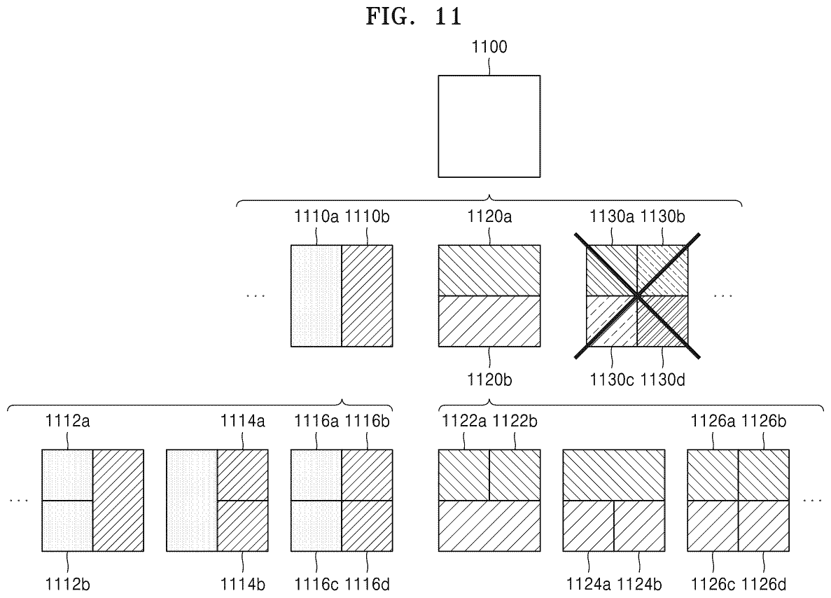

FIG. 11 illustrates a process, performed by the image decoding apparatus 100, of splitting a square coding unit when split shape mode information is unable to indicate that the square coding unit is split into four square coding units, according to an embodiment of the present disclosure.

According to an embodiment of the present disclosure, the image decoding apparatus 100 may determine second coding units 1110a, 1110b, 1120a, 1120b, etc. by splitting a first coding unit 1100, based on split shape mode information. The split shape mode information may include information about various methods of splitting a coding unit, but the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. Based on the split shape mode information, the image decoding apparatus 100 may determine the non-square second coding units 1110a, 1110b, 1120a, 1120b, etc.

According to an embodiment of the present disclosure, the image decoding apparatus 100 may independently split the non-square second coding units 1110a, 1110b, 1120a, 1120b, etc. Each of the second coding units 1110a, 1110b, 1120a, 1120b, etc. may be recursively split in a certain order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

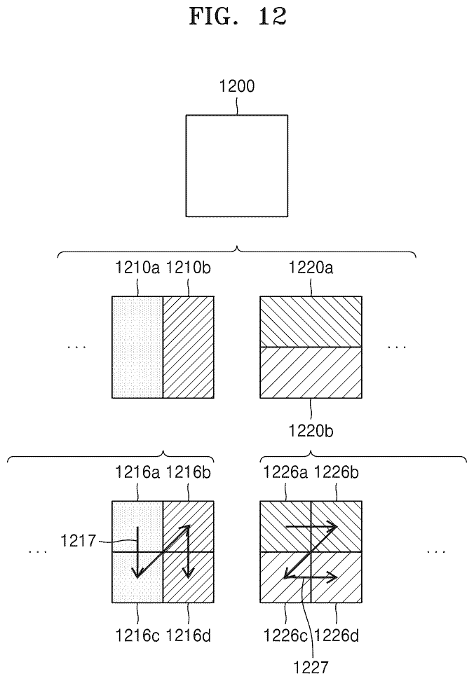

FIG. 12 illustrates that a processing order between a plurality of coding units may be changed depending on a process of splitting a coding unit, according to an embodiment of the present disclosure.

According to an embodiment of the present disclosure, the image decoding apparatus 100 may split a first coding unit 1200, based on split shape mode information. When a block shape indicates a square shape and the split shape mode information indicates to split the first coding unit 1200 in at least one of a horizontal direction or a vertical direction, the image decoding apparatus 100 may determine second coding units (e.g., second coding units 1210a, 1210b, 1220a, 1220b, etc.) by splitting the first coding unit 1200. Referring to FIG. 12, the non-square second coding units 1210a, 1210b, 1220a, and 1220b determined by splitting the first coding unit 1200 in only a horizontal direction or vertical direction may be independently split based on the split shape mode information about each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a horizontal direction. A process of splitting the second coding units 1210a, 1210b, 1220a, and 1220b is described above with reference to FIG. 11, and thus, detailed descriptions thereof are not provided here.

According to an embodiment of the present disclosure, the image decoding apparatus 100 may process coding units in a certain order. The characteristics of processing coding units in a certain order are described above with reference to FIG. 7, and thus, detailed descriptions thereof are not provided here. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment of the present disclosure, the image decoding apparatus 100 may determine processing orders of the third coding units 1216a, 1216b, 1216c, and 1216d, and 1226a, 1226b, 1226c, and 1226d, based on a splitting method of the first coding unit 1200.

According to an embodiment of the present disclosure, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for first processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment of the present disclosure, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for first processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. The second coding units 1210a and 1210b determined by splitting the first coding unit 1200 in a vertical direction have different shapes from the second coding units 1220a and 1220b determined by splitting the first coding unit 1200 in a horizontal direction, but, according to the third coding units 1216a, 1216b, 1216c, and 1216d, and 1226a, 1226b, 1226c, and 1226d which are determined thereafter, the first coding unit 1200 is eventually split into coding units of the same shape. Accordingly, by recursively splitting a coding unit through different processes based on the split shape mode information, even though coding units having the same shape are eventually determined, the image decoding apparatus 100 may process the plurality of coding units determined to have the same shape in different orders.

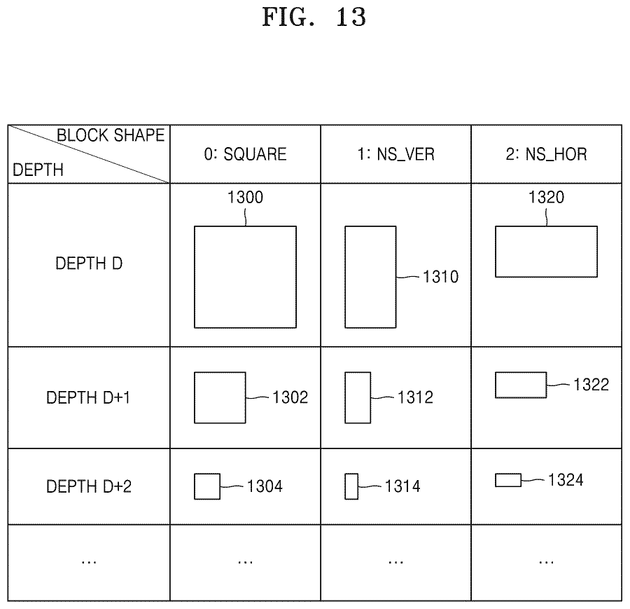

FIG. 13 illustrates a process of determining a depth of a coding unit as a shape and size of the coding unit change, when the coding unit is recursively split such that a plurality of coding units are determined, according to an embodiment of the present disclosure.

According to an embodiment of the present disclosure, the image decoding apparatus 100 may determine the depth of the coding unit, based on a certain criterion. For example, the certain criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. Hereinafter, a coding unit having an increased depth is expressed as a coding unit of a lower depth.

Referring to FIG. 13, according to an embodiment, the image decoding apparatus 100 may determine a second coding unit 1302 and a third coding unit 1304 of lower depths by splitting a square first coding unit 1300 based on block shape information indicating a square shape (e.g., the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment of the present disclosure, the image decoding apparatus 100 may determine a second coding unit 1312 or 1322 and a third coding unit 1314 or 1324 of lower depths by splitting a non-square first coding unit 1310 or 1320 based on block shape information indicating a non-square shape (e.g., the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit (e.g., the second coding unit 1302, 1312, or 1322) by splitting at least one of a width or a height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment of the present disclosure, the image decoding apparatus 100 may determine the second coding unit (e.g., the second coding unit 1302, 1312, or 1322) by splitting at least one of a width or a height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment of the present disclosure, the image decoding apparatus 100 may determine a third coding unit (e.g., the third coding unit 1304, 1314, or 1324) by splitting at least one of a width or a height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment of the present disclosure, the image decoding apparatus 100 may determine the third coding unit (e.g., the third coding unit 1304, 1314, or 1324) by splitting at least one of a width or a height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment of the present disclosure, the image decoding apparatus 100 may determine the third coding unit (e.g., the third coding unit 1304, 1314, or 1324) by splitting at least one of a width or a height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment of the present disclosure, the image decoding apparatus 100 may split the square coding unit (e.g., the square coding unit 1300, 1302, or 1304) in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment of the present disclosure, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

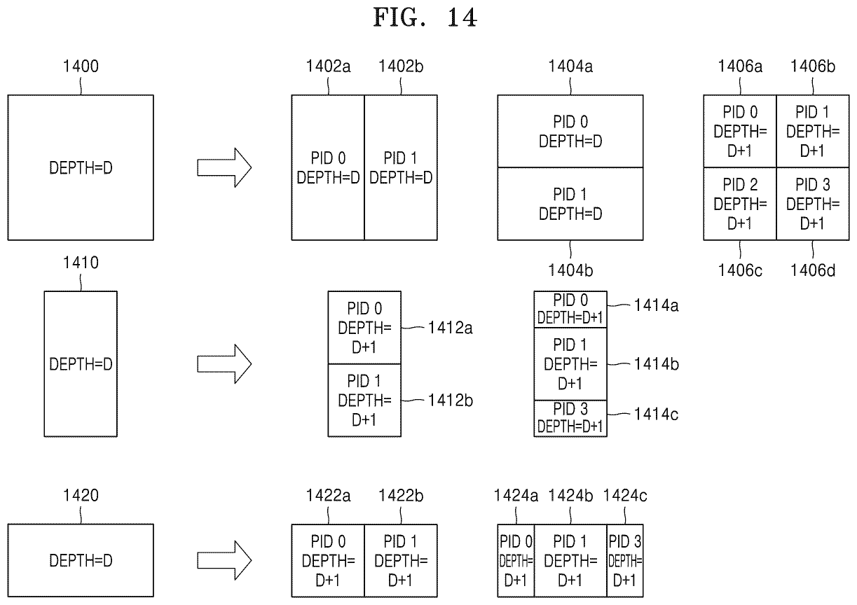

FIG. 14 illustrates depths that are determinable based on shapes and sizes of coding units, and part indexes (PIDs) that are for distinguishing the coding units, according to an embodiment of the present disclosure.

According to an embodiment of the present disclosure, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of a vertical direction or a horizontal direction based on split shape mode information. That is, the image decoding apparatus 100 may determine the second coding units 1402a and 1402b, 1404a and 1404b, and 1406a, 1406b, 1406c, and 1406d, based on the split shape mode information about the first coding unit 1400.

According to an embodiment of the present disclosure, depths of the second coding units 1402a and 1402b, 1404a and 1404b, and 1406a, 1406b, 1406c, and 1406d, which are determined based on the split shape mode information about the square first coding unit 1400, may be determined based on the length of a long side thereof. For example, because the length of a side of the square first coding unit 1400 is the same as the length of a long side of the non-square second coding units 1402a and 1402b, and 1404a and 1404b, the first coding unit 1400 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, depths of the second coding units 1406a, 1406b, 1406c, and 1406d may be D+1 which is lower than the depth D of the first coding unit 1400 by 1.

According to an embodiment of the present disclosure, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment of the present disclosure, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment of the present disclosure, depths of the second coding units 1412a and 1412b, and 1414a, 1414b, and 1414c, or 1422a and 1422b, and 1424a, 1424b, and 1424c that are determined based on the split shape mode information about the non-square first coding unit 1410 or 1420 may be determined based on the length of a long side thereof. For example, because the length of a side of the square second coding units 1412a and 1412b is ½ times the length of a long side of the first coding unit 1410 having a non-square shape, a height of which is longer than a width, depths of the square second coding units 1412a and 1412b is D+1 which is lower than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, depths of the second coding units 1414a, 1414b, and 1414c may be D+1 which is lower than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment of the present disclosure, the image decoding apparatus 100 may determine PIDs for identifying split coding units, based on a size ratio between the coding units when an odd number of split coding units do not have the same size. Referring to FIG. 14, a coding unit 1414b of a center location among an odd number of split coding units 1414a, 1414b, and 1414c may have the same width as those of the other coding units 1414a and 1414c and a height which is two times those of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus, may be 3. That is, discontinuity in PID values may be present. According to an embodiment of the present disclosure, the image decoding apparatus 100 may determine whether an odd number of split coding units do not have equal sizes, based on whether discontinuity is present in PIDs for identifying the split coding units.

According to an embodiment of the present disclosure, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to an embodiment of the present disclosure, the PID may be obtained from a sample of a certain location of each coding unit (e.g., an upper left sample).

According to an embodiment of the present disclosure, the image decoding apparatus 100 may determine a coding unit at a certain location from among the split coding units, by using the PIDs for distinguishing the coding units. According to an embodiment of the present disclosure, when the split shape mode information about the first coding unit 1410 having a rectangular shape, a height of which is longer than a width, indicates to split a coding unit into three coding units, the image decoding apparatus 100 may split the first coding unit 1410 into the three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units so as to determine a coding unit at a center location from among the coding units. The image decoding apparatus 100 may determine the coding unit 1414b having a PID corresponding to a middle value among the PIDs of the coding units, as the coding unit at the certain location from among the coding units determined by splitting the first coding unit 1410. According to an embodiment of the present disclosure, the image decoding apparatus 100 may determine PIDs for distinguishing split coding units, based on a size ratio between the coding units when the split coding units do not have the same size. Referring to FIG. 14, the coding unit 1414b generated by splitting the first coding unit 1410 may have the same width as those of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus, may be 3. When the PID is not uniformly increased as described above, the image decoding apparatus 100 may determine that a coding unit is split into a plurality of coding units including a coding unit having a size different from that of the other coding units. According to an embodiment of the present disclosure, when the split shape mode information indicates to split a coding unit into an odd number of coding units, the image decoding apparatus 100 may split a current coding unit in such a manner that a coding unit of a certain location among an odd number of coding units (e.g., a coding unit of a center location) has a size different from that of the other coding units. In this case, the image decoding apparatus 100 may determine the coding unit of the center location, which has a different size, by using PIDs of the coding units. However, the PIDs and the size or location of the coding unit of the certain location are specified to describe an embodiment, and thus, are not limited to the above-described examples, and various PIDs and various locations and sizes of coding units may be used.

According to an embodiment of the present disclosure, the image decoding apparatus 100 may use a certain data unit where a coding unit starts to be recursively split.

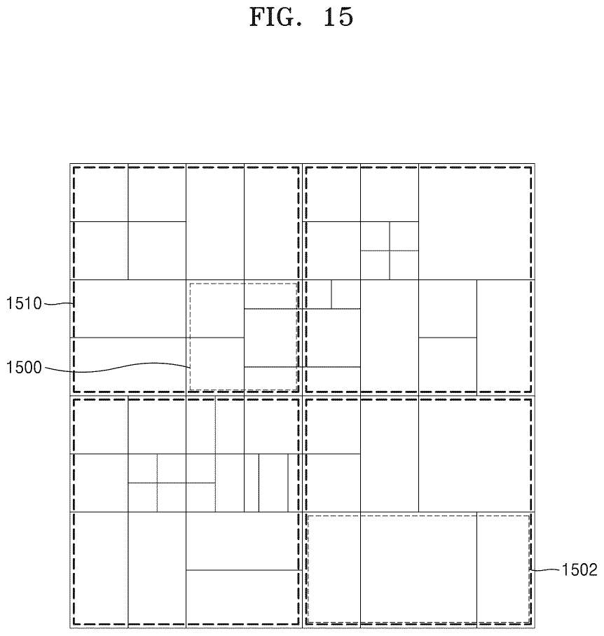

FIG. 15 illustrates that a plurality of coding units are determined based on a plurality of certain data units included in a picture, according to an embodiment of the present disclosure.

According to an embodiment of the present disclosure, a certain data unit may be defined as a data unit where a coding unit starts to be recursively split by using split shape mode information. That is, the certain data unit may correspond to a coding unit of an uppermost depth, which is used to determine a plurality of coding units split from a current picture. Hereinafter, for convenience of description, the certain data unit is referred to as a reference data unit.

According to an embodiment of the present disclosure, the reference data unit may have a certain size and a certain size shape. According to an embodiment of the present disclosure, the reference data unit may include M×N samples. Herein, M and N may be equal to each other, and may be integers expressed as powers of 2. That is, the reference data unit may have a square or non-square shape, and may be then split into an integer number of coding units.

According to an embodiment of the present disclosure, the image decoding apparatus 100 may split the current picture into a plurality of reference data units. According to an embodiment of the present disclosure, the image decoding apparatus 100 may split the plurality of reference data units, which are split from the current picture, by using the split shape mode information about each reference data unit. The process of splitting the reference data unit may correspond to a splitting process using a quadtree structure.

According to an embodiment of the present disclosure, the image decoding apparatus 100 may previously determine the smallest size allowed for the reference data units included in the current picture. Accordingly, the image decoding apparatus 100 may determine various reference data units having sizes equal to or greater than the smallest size, and may determine one or more coding units by using the split shape mode information with respect to the determined reference data unit.

Referring to FIG. 15, the image decoding apparatus 100 may use a square reference coding unit 1500 or a non-square reference coding unit 1502. According to an embodiment of the present disclosure, the shape and size of reference coding units may be determined based on various data units capable of including one or more reference coding units (e.g., sequences, pictures, slices, slice segments, tiles, tile groups, largest coding units, etc.)

According to an embodiment of the present disclosure, the bitstream obtainer 110 of the image decoding apparatus 100 may obtain, from a bitstream, at least one of reference coding unit shape information or reference coding unit size information with respect to each of the various data units. A process of splitting the square reference coding unit 1500 into one or more coding units is described above with reference to the process of splitting the current coding unit 300 of FIG. 3, and a process of splitting the non-square reference coding unit 1502 into one or more coding units is described above with reference to the process of splitting the current coding unit 400 or 450 of FIG. 4, and thus, detailed descriptions thereof are not provided here.

According to an embodiment of the present disclosure, the image decoding apparatus 100 may use a PID for identifying the size and shape of reference coding units, to determine the size and shape of reference coding units according to some data units previously determined based on a certain condition. That is, the bitstream obtainer 110 may obtain, from the bitstream, only the PID for identifying the size and shape of reference coding units with respect to each slice, slice segment, tile, tile group, or largest coding unit which is a data unit satisfying a certain condition (e.g., a data unit having a size equal to or smaller than a slice) among the various data units (e.g., sequences, pictures, slices, slice segments, tiles, tile groups, largest coding units, etc.) The image decoding apparatus 100 may determine the size and shape of reference data units with respect to each data unit, which satisfies the certain condition, by using the PID. When the reference coding unit shape information and the reference coding unit size information are obtained and used from the bitstream according to each data unit having a relatively small size, efficiency of using the bitstream may not be high, and thus, only the PID may be obtained and used instead of directly obtaining the reference coding unit shape information and the reference coding unit size information. In this case, at least one of the size or shape of reference coding units corresponding to the PID for identifying the size and shape of reference coding units may be previously determined. That is, the image decoding apparatus 100 may determine at least one of the size or the shape of reference coding units included in a data unit serving as a unit for obtaining the PID, by selecting the previously determined at least one of the size or the shape of reference coding units based on the PID.

According to an embodiment of the present disclosure, the image decoding apparatus 100 may use one or more reference coding units included in a largest coding unit 1510. That is, the largest coding unit 1510 split from a picture may include one or more reference coding units, and coding units may be determined by recursively splitting each reference coding unit. According to an embodiment of the present disclosure, at least one of a width or a height of the largest coding unit 1510 may be integer times at least one of the width or the height of the reference coding units. According to an embodiment of the present disclosure, the size of reference coding units may be obtained by splitting the largest coding unit n times based on a quadtree structure. That is, the image decoding apparatus 100 may determine the reference coding units by splitting the largest coding unit 1510 n times based on a quadtree structure, and may split the reference coding unit based on at least one of the block shape information or the split shape mode information according to an embodiment of the present disclosure.

According to an embodiment of the present disclosure, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule according to an embodiment of the present disclosure will be described in detail.

The image decoding apparatus 100 may determine a split rule of an image. The split rule may be predetermined between the image decoding apparatus 100 and the image encoding apparatus 200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, or a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a ratio of width and height, and a direction of the coding unit. The image encoding apparatus 200 and the image decoding apparatus 100 may pre-determine to determine the split rule based on the block shape of the coding unit. However, the present disclosure is not limited thereto. The image decoding apparatus 100 may determine the split rule based on the information obtained from the bitstream received from the image encoding apparatus 200.

The shape of the coding unit may include a square and a non-square. When the lengths of the width and height of the coding unit are the same, the image decoding apparatus 100 may determine the shape of the coding unit to be a square. In addition, when the lengths of the width and height of the coding unit are not the same, the image decoding apparatus 100 may determine the shape of the coding unit to be a non-square.

The size of the coding unit may include various sizes such as 4×4, 8×4, 4×8, 8×8, 16×4, 16×8, . . . , 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. In addition, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, 32:1, 1:32, etc. In addition, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

The split rule determined based on the size of the coding unit may be a split rule predetermined between the image encoding apparatus 200 and the image decoding apparatus 100. In addition, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

In addition, the image decoding apparatus 100 may determine the split rule such that coding units generated through different splitting paths do not have the same block shape. However, the present disclosure is not limited thereto, and the coding units generated through different splitting paths have the same block shape. The coding units generated through the different splitting paths may have different decoding processing orders. The decoding processing orders is described above with reference to FIG. 12, and thus, details thereof are not provided again.

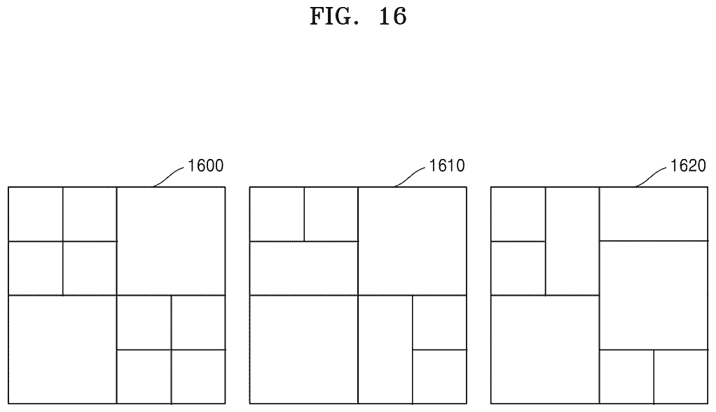

FIG. 16 illustrates coding units which may be determined for each picture, when a combination of shapes into which a coding unit may be split is different for each picture, according to an embodiment of the present disclosure.

Referring to FIG. 16, the image decoding apparatus 100 may, for each picture, differently determine a combination of split shapes into which a coding unit may be split. For example, the image decoding apparatus 100 may decode an image by using a picture 1600 that may be split into four coding units, a picture 1610 that may be split into two or four coding units, and a picture 1620 that may be split into two, three, or four coding units, from among one or more pictures included in the image. In order to split the picture 1600 into a plurality of coding units, the image decoding apparatus 100 may use only split shape information indicating a split into four square coding units. In order to split the picture 1610, the image decoding apparatus 100 may use only split shape information indicating a split into two or four coding units. In order to split the picture 1620, the image decoding apparatus 100 may use only split shape information indicating a split into two, three, or four coding units. The combinations of the split shapes described above are only an embodiment for describing an operation of the image decoding apparatus 100, and thus, the combinations of the split shapes described above should not be interpreted to be limited to the embodiment described above, and should be interpreted such that various types of combinations of the split shapes may be used for a certain data unit.

According to an embodiment of the present disclosure, the bitstream obtainer 110 of the image decoding apparatus 100 may obtain a bitstream including an index indicating a combination of split shape information for each certain data unit (for example, a sequence, a picture, a slice, a slice segment, a tile, or a tile group). For example, the bitstream obtainer 110 may obtain the index indicating the combination of the split shape information from a sequence parameter set, a picture parameter set, a slice header, a tile header, or a tile group header. The image decoding apparatus 100 may determine, for each certain data unit, a combination of split shapes into which a coding unit may be split by using the obtained index, and accordingly, for each certain data unit, a different combination of the split shapes may be used.

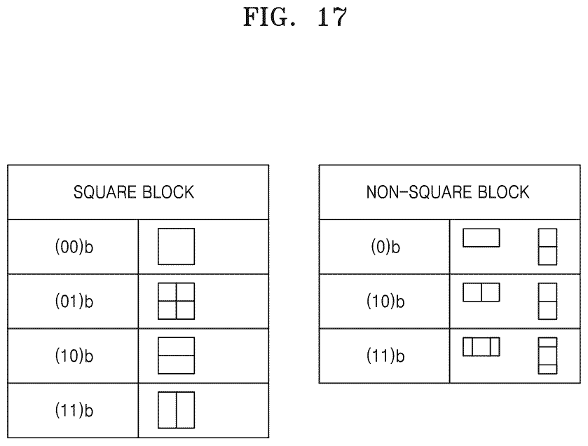

FIG. 17 illustrates various shapes of a coding unit, which may be determined based on split shape mode information which may be expressed as a binary code, according to an embodiment of the present disclosure.

According to an embodiment of the present disclosure, the image decoding apparatus 100 may split the coding unit into various shapes by using block shape information and split shape mode information obtained by the bitstream obtainer 110. Shapes into which the coding unit may be split may correspond to various shapes including the shapes described according to the embodiments described above.

Referring to FIG. 17, the image decoding apparatus 100 may split a square coding unit in at least one of a horizontal direction and a vertical direction and may split a non-square coding unit in the horizontal direction or the vertical direction, based on the split shape mode information.

According to an embodiment of the present disclosure, when the image decoding apparatus 100 may split a square coding unit in the horizontal direction and the vertical direction into four square coding units, split shapes which may be indicated by the split shape mode information about the square coding unit may correspond to four types. According to an embodiment of the present disclosure, the split shape mode information may be expressed as a two-digit binary code, and each split shape may be assigned with a binary code. For example, when a coding unit is not split, the split shape mode information may be expressed as (00)b, when a coding unit is split in a horizontal direction and a vertical direction, the split shape mode information may be expressed as (01)b, when a coding unit is split in the horizontal direction, the split shape mode information may be expressed as (10)b, and when a coding unit is split in the vertical direction, the split shape mode information may be expressed as (11)b.

According to an embodiment of the present disclosure, when the image decoding apparatus 100 splits a non-square coding unit in a horizontal direction or a vertical direction, split shape types which may be indicated by the split shape mode information may be determined depending on the number of coding units into which the non-square coding unit is split. Referring to FIG. 17, the image decoding apparatus 100 may split up to three coding units from a non-square coding unit, according to an embodiment of the present disclosure. The image decoding apparatus 100 may split a coding unit into two coding units, and in this case, the split shape mode information may be expressed as (10)b. The image decoding apparatus 100 may split a coding unit into three coding units, and in this case, the split shape mode information may be expressed as (11)b. The image decoding apparatus 100 may determine not to split a coding unit, and in this case, the split shape mode information may be expressed as (0)b. That is, to use the binary code indicating the split shape mode information, the image decoding apparatus 100 may use variable length coding (VLC) rather than fixed length coding (FLC).

Referring to FIG. 17, according to an embodiment of the present disclosure, a binary code of the split shape mode information indicating not to split the coding unit may be expressed as (0)b. When the binary code of the split shape mode information indicating not to split the coding unit is configured as (00)b, all of 2-bit binary codes of the split shape mode information may have to be used, even though there is no split shape mode information configured as (01)b. However, when, as shown in FIG. 17, three split shape types with respect to the non-square coding unit are used, the image decoding apparatus 100 may determine not to split the coding unit, even by using a 1-bit binary code (0) b as the split shape mode information, thereby efficiently using a bitstream. However, the split shapes of the non-square coding unit indicated by the split shape mode information should not be interpreted as being limited to the three split shape types shown in FIG. 17 and should be interpreted to include various shapes including the embodiments described above.

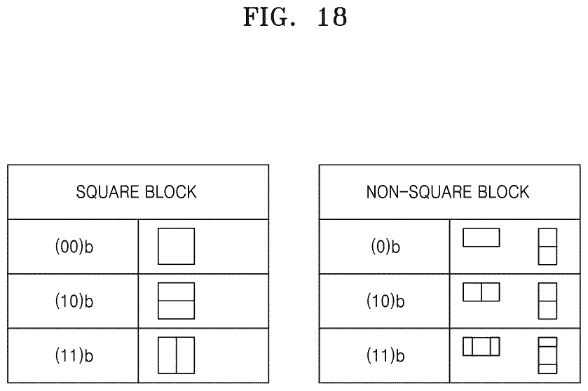

FIG. 18 illustrates another shape of a coding unit, which may be determined based on split shape mode information which may be expressed as a binary code, according to an embodiment of the present disclosure.

Referring to FIG. 18, the image decoding apparatus 100 may split a square coding unit in a horizontal direction or a vertical direction and may split a non-square coding unit in the horizontal direction or the vertical direction, based on the split shape mode information. That is, the split shape mode information may indicate to split the square coding unit in one direction. In this case, a binary code of the split shape mode information indicating not to split the square coding unit may be expressed as (0)b. When the binary code of the split shape mode information indicating not to split the coding unit is configured as (00)b, all of 2-bit binary codes of the split shape mode information may have to be used, even though there is no split shape mode information configured as (01)b. However, when, as shown in FIG. 18, three split shape types with respect to the square coding unit are used, the image decoding apparatus 100 may determine not to split the coding unit, even by using a 1-bit binary code (0) b as the split shape mode information, thereby efficiently using a bitstream. However, the split shapes of the square coding unit indicated by the split shape mode information should not be interpreted as being limited to the three split shape types shown in FIG. 18 and should be interpreted to include various shapes including the embodiments described above.

According to an embodiment of the present disclosure, the block shape information or the split shape mode information may be expressed using a binary code, and the block shape information or the split shape mode information may be directly generated as a bitstream. In addition, the block shape information or the split shape mode information which may be expressed as a binary code may not be directly generated as a bitstream and may be used as a binary code which is input in context adaptive binary arithmetic coding (CABAC).

According to an embodiment of the present disclosure, a process in which the image decoding apparatus 100 obtains syntax with respect to the block shape information or the split shape mode information through the CABAC, is described. A bitstream including a binary code with respect to the syntax may be obtained by the bitstream obtainer 110. The image decoding apparatus 100 may detect a syntax element indicating the block shape information or the split shape mode information by inverse binarizing a bin string included in the obtained bitstream. According to an embodiment of the present disclosure, the image decoding apparatus 100 may obtain a set of binary bin strings corresponding to a syntax element to be decoded and may decode each bin by using probability information, and may repeat this process until a bin string composed of these decoded bins becomes the same as one of previously obtained bin strings. The image decoding apparatus 100 may determine the syntax element by performing inverse binarization on the bin string.

According to an embodiment of the present disclosure, the image decoding apparatus 100 may determine the syntax with respect to the bin string by performing a decoding process of adaptive binary arithmetic coding, and the image decoding apparatus 100 may update a probability model with respect to the bins obtained by the bitstream obtainer 110. Referring to FIG. 17, the bitstream obtainer 110 of the image decoding apparatus 100 may obtain a bitstream indicating a binary code indicating split shape mode information, according to an embodiment of the present disclosure. The image decoding apparatus 100 may determine the syntax with respect to the split shape mode information by using the obtained 1-bit or 2-bit-sized binary code. In order to determine the syntax with respect to the split shape mode information, the image decoding apparatus 100 may update a probability with respect to each bit of the 2-bit binary code. That is, according to whether a value of a first bin of the 2-bit binary code is 0 or 1, the image decoding apparatus 100 may update a probability for a next bin of having the value of 0 or 1 when the next bin is decoded.

According to an embodiment of the present disclosure, in the process of determining the syntax, the image decoding apparatus 100 may update the probability with respect to the bins, in a process of decoding the bins of the bin string with respect to the syntax, and with respect to a certain bit from among the bin string, the image decoding apparatus 100 may not update the probability and may determine that the probability is the same.

Referring to FIG. 17, in a process of determining the syntax by using the bin string indicating the split shape mode information about the non-square coding unit, the image decoding apparatus 100 may determine the syntax with respect to the split shape mode information by using one bin having a value of 0, when the non-square coding unit is not split. That is, when the block shape information indicates that a current coding unit has a non-square shape, a first bin of the bin string with respect to the split shape mode information may be 0, when the non-square coding unit is not split, and may be 1, when the non-square coding unit is split into two or three coding units. Accordingly, the probability that the first bin of the bin string of the split shape mode information about the non-square coding unit is 0 may be ⅓, and the probability that the first bin of the bin string of the split shape mode information about the non-square coding unit is 1 may be ⅔. As described above, because the split shape mode information indicating that the non-square coding unit is not split may be expressed by using only a 1-bit bin string having the value of 0, the image decoding apparatus 100 may determine the syntax with respect to the split shape mode information by determining whether a second bin is 0 or 1, only when the first bin of the split shape mode information is 1. According to an embodiment of the present disclosure, when the first bin with respect to the split shape mode information is 1, the image decoding apparatus 100 may regard that the probability that the second bin is 0 and the probability that the second bin is 1 are the same as each other and may decode the bin.

According to an embodiment of the present disclosure, in the process of determining the bins of the bin string with respect to the split shape mode information, the image decoding apparatus 100 may use various probabilities with respect to each bin. According to an embodiment of the present disclosure, the image decoding apparatus 100 may differently determine the probabilities of the bins with respect to the split shape mode information, according to a direction of a non-square block. According to an embodiment of the present disclosure, the image decoding apparatus 100 may differently determine the probabilities of the bins with respect to the split shape mode information, according to a width or a length of a longer side of a current coding unit. According to an embodiment of the present disclosure, the image decoding apparatus 100 may differently determine the probabilities of the bins with respect to the split shape mode information, according to at least one of a shape and a length of a longer side of a current coding unit.

According to an embodiment of the present disclosure, the image decoding apparatus 100 may determine that the probabilities of the bins with respect to the split shape mode information are the same for coding units having a size that is equal to or greater than a certain size. For example, the image decoding apparatus 100 may determine that the probabilities of the bins with respect to the split shape mode information are the same as each other with respect to the coding units having a size that is equal to or greater than 64 samples based on a length of a longer side of the coding unit.

According to an embodiment of the present disclosure, the image decoding apparatus 100 may determine initial probabilities of the bins composed in the bin string of the split shape mode information based on a slice type (for example, an I-slice, a P-slice, or a B-slice).

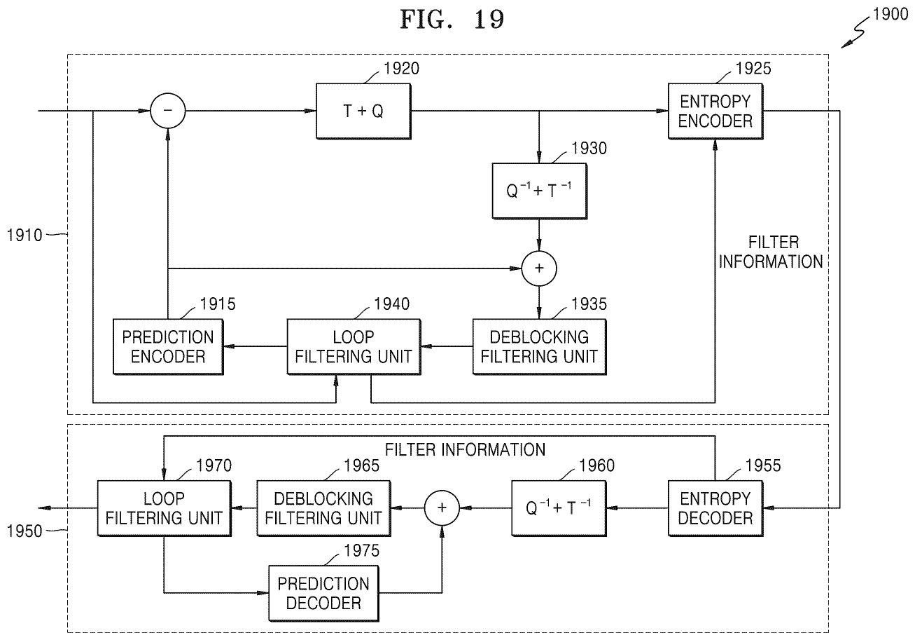

FIG. 19 illustrates a block diagram of an image encoding and decoding system performing loop filtering.

An encoding end 1910 of an image encoding and decoding system 1900 transmits an encoded bitstream of an image and a decoding end 1950 outputs a reconstructed image by receiving and decoding the bitstream. Here, the encoding end 1910 may have a similar configuration as the image encoding apparatus 200 to be described below, and the decoding end 1950 may have a similar configuration as the image decoding apparatus 100.

In the encoding end 1910, a prediction encoder 1915 outputs prediction data via inter prediction and intra prediction, and a transformer and quantizer 1920 outputs a quantized transform coefficient of residual data between the prediction data and a current input image. An entropy encoder 1925 encodes and transforms the quantized transform coefficient and outputs the quantized transform coefficient as a bitstream. The quantized transform coefficient is reconstructed as data of a spatial domain via an inverse quantizer and inverse transformer 1930, and the reconstructed data of the spatial domain is output as a reconstructed image via a deblocking filtering unit 1935 and a loop filtering unit 1940. The reconstructed image may be used as a reference image of a next input image via the prediction encoder 1915.

Encoded image data among the bitstream received by the decoding end 1950 is reconstructed as residual data of the spatial domain via an entropy decoder 1955 and an inverse quantizer and inverse transformer 1960. Prediction data and residual data that are output from a prediction decoder 1975 may be combined to construct image data of the spatial domain, and a deblocking filtering unit 1965 and a loop filtering unit 1970 may perform filtering on the image data of the spatial domain to output a reconstructed image with respect to a current original image. The reconstructed image may be used as a reference image for a next original image via the prediction decoder 1975.

The loop filtering unit 1940 of the encoding end 1910 performs loop filtering using filter information input according to a user input or system setting. The filter information used by the loop filtering unit 1940 is output to the entropy encoder 1925 and transmitted to the decoding end 1950 together with the encoded image data. The loop filtering unit 1970 of the decoding end 1950 may perform loop filtering based on the filter information input from the decoding end 1950.

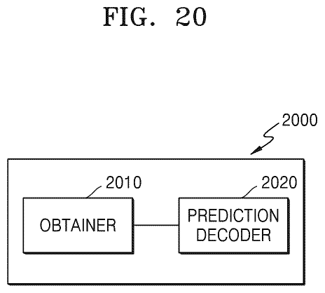

FIG. 20 is a diagram illustrating components of an image decoding apparatus according to an embodiment of the present disclosure.

Referring to FIG. 20, an image decoding apparatus 2000 may include an obtainer 2010 and a prediction decoder 2020.

According to an embodiment of the present disclosure, the obtainer 2010 and the prediction decoder 2020 may be implemented as at least one processor. According to an embodiment of the present disclosure, the image decoding apparatus 2000 may include memory storing at least one of input and output data or an instruction of the obtainer 2010 and the prediction decoder 2020. The obtainer 2010 and the prediction decoder 2020 may operate according to the instruction stored in the memory. According to an embodiment of the present disclosure, the image decoding apparatus 2000 may include a memory controller that controls data input/output of the memory.

According to an embodiment of the present disclosure, the obtainer 2010 may correspond to the entropy decoder 1955 shown in FIG. 19. According to an embodiment of the present disclosure, the prediction decoder 2020 may correspond to the prediction decoder 1975 shown in FIG. 19.

The obtainer 2010 may obtain a bitstream generated as a result of encoding an image. The bitstream may include an encoding result with respect to a current block. According to an embodiment of the present disclosure, the obtainer 2010 may receive the bitstream from an image encoding apparatus through a network. According to an embodiment of the present disclosure, the obtainer 2010 may obtain the bitstream from a data storage medium including at least one of a magnetic medium such as a hard disk, a floppy disk, and a magnetic tape, an optical recording medium such as a compact disk read-only memory (CD-ROM) and a digital versatile disk (DVD), or a magneto-optical medium such as a floptical disk.

The obtainer 2010 may obtain, from the bitstream, syntax elements for decoding an image. Values corresponding to the syntax elements may be included in the bitstream according to a hierarchical structure of an image. According to an embodiment of the present disclosure, the obtainer 2010 may obtain the syntax elements by entropy decoding bins included in the bitstream.

According to an embodiment of the present disclosure, the bitstream may include information about the prediction mode of the current block in a current image. The current block may include at least one of a largest coding unit, a coding unit, a transform unit, or a prediction unit that are split from the current image to be decoded. According to an embodiment of the present disclosure, a prediction mode such as an intra mode, an inter mode, a combined mode, a geometric partitioning mode (GPM), and/or an intra block copy (IBC) may be used for prediction of the current block. According to an embodiment, the intra mode may be performed according to a template matching-based prediction method. According to an embodiment, a block copy mode may include an IBC mode. According to an embodiment, a template matching-based prediction mode may include a template matching-based intra prediction mode. The combined mode may include a combined inter intra prediction (CIIP) mode in which prediction is performed by combining prediction according to the intra mode and prediction according to the inter mode. The GPM may include a splitting mode to have directionality in a block. The GPM may perform prediction using inter prediction or intra prediction with respect to each of split areas of the block. The prediction mode according to an embodiment of the present disclosure will be described below.

The prediction decoder 2020 may reconstruct the current block by performing, on the current block, prediction according to the prediction mode, based on the prediction mode of the current block.

According to an embodiment of the present disclosure, the obtainer 2010 may obtain information about the prediction mode of the current block from a bitstream. For example, the obtainer 2010 may obtain index information indicating the prediction mode of the current block from the bitstream.

According to an embodiment of the present disclosure, when the prediction mode of the current block is the CIIP mode, the prediction decoder 2020 may reconstruct the current block by combining inter prediction and intra prediction. For example, the prediction decoder 2020 may perform intra prediction according to a planar mode. For example, the prediction decoder 2020 may perform inter prediction using a motion vector. The prediction decoder 2020 may reconstruct the current block by using a weighted sum of a prediction block according to inter prediction and a prediction block of intra prediction. A weight may be determined based on whether a block adjacent to the current block is intra predicted.

According to an embodiment of the present disclosure, when the prediction mode of the current block is the GPM, the prediction decoder 2020 may perform prediction by splitting the current block. The prediction decoder 2020 may obtain a split angle and a split distance with respect to an edge on which splitting in the current block is performed. The prediction decoder 2020 may split the current block based on the split angle and the split distance. The prediction decoder 2020 may reconstruct the current block by performing inter prediction or intra prediction on each of split areas in the current block. The prediction decoder 2020 may (i) perform intra prediction on both of the split areas, (ii) perform inter prediction on one area and intra prediction on the other area, or (iii) perform inter prediction on both of the split areas.

According to an embodiment of the present disclosure, when the prediction mode of the current block is the block copy mode, the prediction decoder 2020 may reconstruct the current block based on a reference block included in a current image. According to an embodiment of the present disclosure, the prediction decoder 2020 may determine a prediction block based on the reference block. For example, the prediction decoder 2020 may determine the prediction block to be same as the reference block or determine the prediction block by performing filtering on the reference block.

According to an embodiment of the present disclosure, when the prediction mode of the current block is the template matching prediction mode, the prediction decoder 2020 may reconstruct the current block by using the reference block. The prediction decoder 2020 may determine the prediction block by performing template matching-based intra prediction on the current image.

The prediction decoder 2020 may generate the reconstructed current block by using the prediction block. According to an embodiment of the present disclosure, the prediction decoder 2020 may determine the prediction block as the reconstructed current block. According to an embodiment, the prediction decoder 2020 may generate the reconstructed current block by combining residual data obtained by the obtainer 2010 from a bitstream with the prediction block. The reconstructed current block may be used as a reference block for a next block.

In the intra mode, the prediction block of the current block may be generated based on neighboring samples of the current block according to intra prediction mode, assuming that there is a continuity between the neighboring samples of the current block and samples in the current block. The prediction decoder 2020 according to an embodiment of the present disclosure may use not only the neighboring samples of the current block included in the current image, but also a spatial reference sample included in the current image for intra prediction. When a sample reconstructed before the current block is used, not only samples directly adjacent to the current block, but also samples far from the current block may be used to predict the samples of the current block, and thus, a size of residual data may be reduced. According to an embodiment of the present disclosure, the image decoding apparatus 2000 may perform intra prediction using the reference block including a sample not reconstructed, and thus, a range of an area which may be determined as the reference block may be increased. The image decoding apparatus 2000 according to an embodiment of the present disclosure may increase intra prediction efficiency, thereby improving the compression efficiency.

The prediction decoder 2020 may perform deblocking filtering. A deblocking filter may improve image quality by smoothing an edge between blocks.

The prediction decoder 2020 may perform filtering on the sample of the current block on which deblocking filtering is performed, using a sample adaptive offset (SAO) filter and/or a bilateral filter (BIF). The SAO filter and the BIF may improve the image quality by reducing an error between a reconstructed image and an original image. The SAO filter and the BIF may perform filtering in a sample unit.

The prediction decoder 2020 may perform filtering using an adaptive loop filter (ALF). The ALF may improve the image quality by reducing an error between a reconstructed image and an original image. The ALF may perform filtering in a block unit.

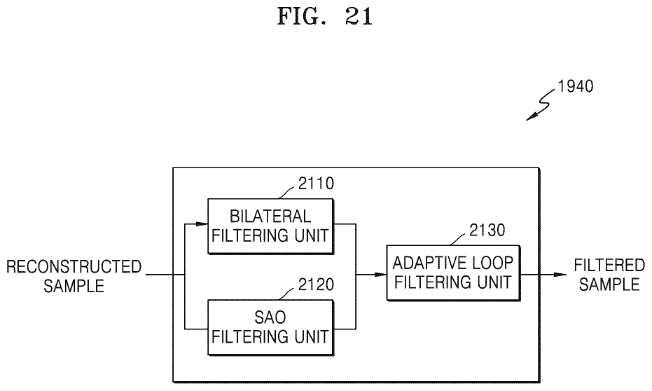

FIG. 21 is a block diagram illustrating components of a loop filtering unit according to an embodiment of the present disclosure.

Referring to FIG. 21, the loop filtering unit 1940 may generate a filtered sample by performing filtering a reconstructed sample. According to an embodiment of the present disclosure, the loop filtering unit 1940 may include a bilateral filtering unit 2110, a SAO filtering unit 2120, and an adaptive loop filtering unit 2130.

According to an embodiment of the present disclosure, the reconstructed sample may be a sample on which deblocking filtering has been performed. A deblocking filter may modify values of a plurality of samples near a boundary between a current block and a neighboring block. The deblocking filter may modify the values of the samples by applying a deblocking filter coefficient to each of a sample near the boundary of the current block and a sample near the boundary of the neighboring block.

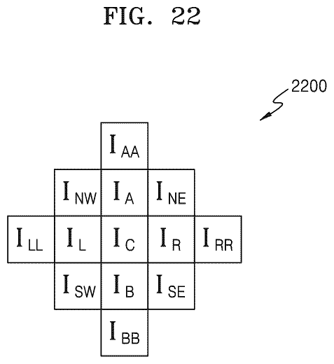

The bilateral filtering unit 2110 may perform filtering on a current sample using neighboring samples of the current sample. The bilateral filtering unit 2110 may perform filtering on a sample of a luma component and a sample of a chroma component. The bilateral filtering unit 2110 may determine a BIF offset value ΔI_{BIF} with respect to the current sample. The offset value may include a change amount of the current sample according to filtering. The bilateral filtering unit 2110 may determine a filtering intensity based on differences between the current sample and the neighboring samples. For example, the bilateral filtering unit 2110 may apply stronger filtering as a difference between the current sample and the neighboring sample increases. That is, the bilateral filtering unit 2110 may have a large difference of the current sample before and after filtering. A BIF according to an embodiment of the present disclosure will be described in detail with reference to FIGS. 22 to 33.

The SAO filtering unit 2120 may determine a SAO offset value ΔI_{SAO} with respect to the current sample. The SAO filtering unit 2120 may determine an edge offset or a band offset. The SAO filtering unit 2120 may determine whether a SAO type of the current block is an edge offset.

According to an embodiment of the present disclosure, the SAO filtering unit 2120 may obtain an edge offset class from a bitstream. The edge offset class may indicate a representative edge among a horizontal edge, a vertical edge, a 135-degree edge, or a 45-degree edge. The SAO filtering unit 2120 may determine an edge offset category based on a category condition. The category condition may include a size condition between values of samples at a location determined based on the edge offset class. The SAO filtering unit 2120 may determine an offset based on the edge offset category.

According to an embodiment of the present disclosure, the SAO filtering unit 2120 may determine a plurality of bands according to the brightness of a pixel. The SAO filtering unit 2120 may obtain offset values corresponding to the plurality of bands from the bitstream. The plurality of bands may include consecutive bands. The SAO filtering unit 2120 may determine a band corresponding to the current sample. The SAO filtering unit 2120 may determine an offset value corresponding to the determined band as an offset value with respect to the current sample.

According to an embodiment of the present disclosure, the filtered current sample may be determined using the BIF offset value determined by the bilateral filtering unit 2110 and the SAO offset value determined by the SAO filtering unit 2120. For example, the filtered current sample may be determined by the sum of the reconstructed current sample, the BIF offset value, and the SAO offset value. The filtered current sample may not be greater than a bit depth of an image.

The adaptive loop filtering unit 2130 may determine a filter coefficient that minimizes an error between the original image and a reconstructed image. The adaptive loop filtering unit 2130 may determine a class or a filter coefficient based on the characteristics of the current block. For example, the adaptive loop filtering unit 2130 may determine a class of an N×N block and determine the filter coefficient based on the class. The class of the block may be determined based on a direction and activity of a pixel in the block. The adaptive loop filtering unit 2130 may perform geometric transformation on the filter based on an inclination in the block. The inclination in the block may include a horizontal inclination, a vertical inclination, and two diagonal inclinations. The geometric transformation may include at least one of a diagonal symmetric transformation, a vertical symmetric transformation, or a rotation transformation. The adaptive loop filtering unit 2130 may perform filtering using a filter coefficient. The adaptive loop filtering unit 2130 may perform filtering by applying the filter coefficient to differences between values of the current sample and the neighboring sample.

According to an embodiment of the present disclosure, the loop filtering unit 1940 may not include at least some of the bilateral filtering unit 2110, the SAO filtering unit 2120, and the adaptive loop filtering unit 2130. For example, only bilateral filtering may be performed on the reconstructed sample by the bilateral filtering unit 2110. Whether the bilateral filtering unit 2110, the SAO filtering unit 2120, and the adaptive loop filtering unit 2130 perform filtering may be obtained through a bitstream. Whether the bilateral filtering unit 2110 and the SAO filtering unit 2120 perform filtering may be determined using rate distortion optimization (RDO). That is, whether to apply filtering may be determined through an optimization process using the quality of the image and the number of bits included in the bitstream. The image decoding apparatus 2000 may obtain, from the bitstream, information indicating whether to perform filtering. The image decoding apparatus 2000 may perform filtering based on the obtained information. According to an embodiment of the present disclosure, the bilateral filtering unit 2110 and the SAO filtering unit 2120 may be sequentially performed without being performed in parallel.

According to an embodiment of the present disclosure, the loop filtering unit 1970 may be configured to be the same as the loop filtering unit 1940. The loop filtering unit 1970 may include a bilateral filtering unit, a SAO filtering unit, and/or an adaptive loop filtering unit.

FIG. 22 is a diagram for describing a shape of a bilateral filter (BIF) according to an embodiment of the present disclosure.

Referring to FIG. 22, a BIF 2200 may be a filter in the shape of a 5×5 diamond. However, the present disclosure is not limited thereto, and the BIF may be a filter in the shape of an N×N diamond such as 3×3 or 7×7.

The BIF 2200 according to an embodiment of the present disclosure may include a center sample and neighboring samples. The center sample I_{C} may refer to a current sample in which filtering is performed. The neighboring samples may include an above sample I_{A} located above the center sample, a left sample I_{L} located at the left of the center sample, a below sample I_{B} located below the center sample, and a right sample I_{R} located at the right of the center sample. The neighboring samples may include a northwest sample I_{NW} located at above left of the center sample, a southwest sample I_{SW} located at below left of the center sample, a southeast sample I_{SE} located at below right of the center sample, and a northeast sample I_{NE} located at above right of the center sample. The neighboring samples may include an above-above sample I_{AA} located above the above sample, a left-left sample I_{LL} located at the left of the left sample, a below-below sample I_{BB} located below the below sample, and a right-right sample I_{RR} located at the right of the right sample.

The image decoding apparatus 2000 may determine a difference between the center sample and the neighboring sample. For example, a difference ΔI_{R} between the center sample and the right sample may be determined as shown in Equation 1.

ΔI_{R}=(|I_{R}−I_{C}|+2ⁿ⁻⁸)>>(n−7) [Equation 1]

Here, |′| denotes an absolute value, and n denotes a bit depth of an image. According to an embodiment of the present disclosure, Equation 1 may be calculated by rounding the difference ΔI_{R} by a value obtained by right shifting the difference between the center sample and the neighboring sample by n bits. For example, in a 10-bit image, the difference ΔI_{R} may be determined as (|I_{R}−I_{C}|+4)>>3. According to an embodiment of the present disclosure, the difference may be expressed as a quantization of the absolute value of the difference between the center sample and the neighboring sample.

According to an embodiment of the present disclosure, the image decoding apparatus 2000 may determine an offset value by using the difference ΔI_{R} between the center sample I_{C} and the neighboring sample. The image decoding apparatus 2000 may obtain a predefined lookup table (LUT). The LUT may include a plurality of indexes and a plurality of values respectively corresponding to the plurality of indexes. For example, the LUT may include 16 values of 0, 1, 1, 1, 1, 0, 0, 0, 0, 0, 0, 0, 0, 0, 0, 0}. LUT[i] denotes a value corresponding to an index i, and LUT[0] denotes a 0th value of the LUT, that is, 0 which is the leftmost value. According to an embodiment of the present disclosure, the LUT may be determined based on a quantization parameter. According to an embodiment of the present disclosure, the LUT may be determined according to a prediction mode.

According to an embodiment of the present disclosure, the image decoding apparatus 2000 may determine a modifier value μ according to the difference by using the LUT. According to an embodiment of the present disclosure, a modifier value μ_{ΔIR} corresponding to the right sample may be determined as an output value of the LUT corresponding to the difference ΔI_{R} between the center sample and the right sample. For example, the modifier value may be determined as LUT[ΔI_{R}].

According to an embodiment of the present disclosure, the modifier value μΔI_{R} corresponding to the right sample may be determined based on the number of values included in the LUT. For example, the modifier value may be determined as LUT[min (15, ΔI_{R})]. When the number of values included in the LUT is 16, the upper limit may be determined to be 15, and one of 0 to 15 may be determined as an index of the LUT. Accordingly, even when the difference between the center sample and the neighboring sample is greater than a certain value, the modifier value may be obtained from the LUT.

According to an embodiment of the present disclosure, the modifier value μ_{ΔIR} corresponding to the right sample may be determined based on whether the difference between the center sample and the right sample is greater than 0. For example, when the difference between the center sample and the right sample is less than 0, the modifier value μ_{ΔIR} may be determined as a negative of the output value of the LUT.

According to an embodiment of the present disclosure, the modifier value may be determined based on a distance between the neighboring sample and the center sample. According to an embodiment of the present disclosure, when the distance between the center sample and the neighboring sample is 2, the modifier value may be obtained by dividing the value obtained according to the LUT by 2. For example, a modifier value μ_{ΔAA} corresponding to the above-above sample may be determined as LUT[ΔI_{AA}]>>1. According to an embodiment of the present disclosure, a LUT according to the distance between the neighboring sample and the center sample may be applied as the modifier value. For example, the modifier value of a neighboring sample at a distance of 1 from the center sample and the modifier value of a neighboring sample at a distance of 2 from the center sample may be determined through different LUTs.

According to an embodiment of the present disclosure, the process of determining the modifier value has been described with respect to the above sample, but is not limited thereto, and may be equally applied to other neighboring samples.

According to an embodiment of the present disclosure, the image decoding apparatus 2000 may determine an offset value based on the modifier value. The image decoding apparatus 2000 may determine the sum of the modifier values. According to an embodiment of the present disclosure, the image decoding apparatus 2000 may determine the sum of the modifier values with respect to the neighboring samples included in the BIF. For example, the image decoding apparatus 2000 may determine a sum mₛᵤₘ of the modifier values u corresponding to the neighboring samples, as shown in Equation 2.

mₛᵤₘ=μ_{ΔA}+μ_{ΔB}+μ_{ΔL}+μ_{ΔR}+μ_{ΔNW}+μ_{ΔNE}+μ_{ΔSW}+μ_{ΔSE}+μ_{ΔAA}+μ_{ΔBB}+μ_{ΔLL}+μ_{ΔRR} [Equation 2]

The image decoding apparatus 2000 may determine the offset value based on the sum of the modifier values. The image decoding apparatus 2000 may determine a filtering parameter based on the sum of the modifier values.

According to an embodiment of the present disclosure, the image decoding apparatus 2000 may determine a multiplier value. In the present disclosure, the multiplier value may be referred to as a “c parameter”. The image decoding apparatus 2000 may determine the multiplier value based on at least some of the width of a block including the center sample, the height of the block, the minimum value of the width and height of the block, or a prediction mode of the block. For example, the image decoding apparatus 2000 may determine one of predetermined multiplier values based on the minimum value of the width and height of the block. For example, the image decoding apparatus 2000 may determine a predetermined multiplier value in response to the prediction mode of the block indicating an inter prediction mode or an intra prediction mode. The multiplier value may be determined as one of certain values. For example, the multiplier value may be determined as one of 1, 2, or 3.

According to an embodiment of the present disclosure, the image decoding apparatus 2000 may determine a filtering parameter based on the multiplier value and the sum of the modifier values. The filtering parameter may be determined by multiplying the multiplier value by the sum of the modifier values.

The image decoding apparatus 2000 may determine an offset value based on the filtering parameter. According to an embodiment of the present disclosure, the image decoding apparatus 2000 may determine the offset value based on a bilateral filtering intensity. The image decoding apparatus 2000 may obtain a filtering intensity. The image decoding apparatus 2000 may determine the offset value by adjusting the filtering parameter according to the filtering intensity. For example, the image decoding apparatus 2000 may determine the filtering parameter as shown in Equation 3.

r_{add}=2^{14-n-bilateral_filter_intensity}

r_{shift}=15−n−bilateral_filter_intensity

ΔI_{BIF}=(cᵥ+r_{add})>>r_{shift}[Equation 3]

Here, n denotes a bit depth of an image, and bilatal_filter_intensity denotes a bilateral filtering intensity. The bilateral filtering intensity may indicate a value of 0 or 1. According to an embodiment of the present disclosure, the bilateral filtering intensity may be signaled through a picture parameter set (PPS) of a bitstream.

The image decoding apparatus 2000 may obtain a filtered sample by using the center sample and the offset value. The image decoding apparatus 2000 may perform filtering by summing the center sample and the offset values. For example, the image decoding apparatus 2000 may perform filtering as shown in Equation 4.

Iₒᵤₜ=clip3(0,(1<<BitDepth)−1,I_{C}+ΔI_{BIF}) [Equation 4]

Here, a clip3(x, y, z) function is a function that outputs a value of a variable z between a lower limit x and an upper limit y, outputs the lower limit x when the variable z is less than the lower limit x, and outputs the upper limit y when the variable z is greater than the upper limit y. Here, Iₒᵤₜ denotes a value of the filtered sample, I_{C} denotes a value of the center sample, and ΔI_{BIF} denotes an offset value with respect to the BIF.

According to an embodiment of the present disclosure, the image decoding apparatus 2000 may obtain a filtered sample by using a SAO filter. For example, the image decoding apparatus 2000 may perform filtering using BIF and a SAO filter, as shown in Equation 5.

Iₒᵤₜ=clip3(0,(1<<BitDepth)−1,I_{C}+ΔI_{BIF}+ΔI_{SAO}) [Equation 5]

Here, ΔI_{BIF} denotes an offset value with respect to the SAO filter.

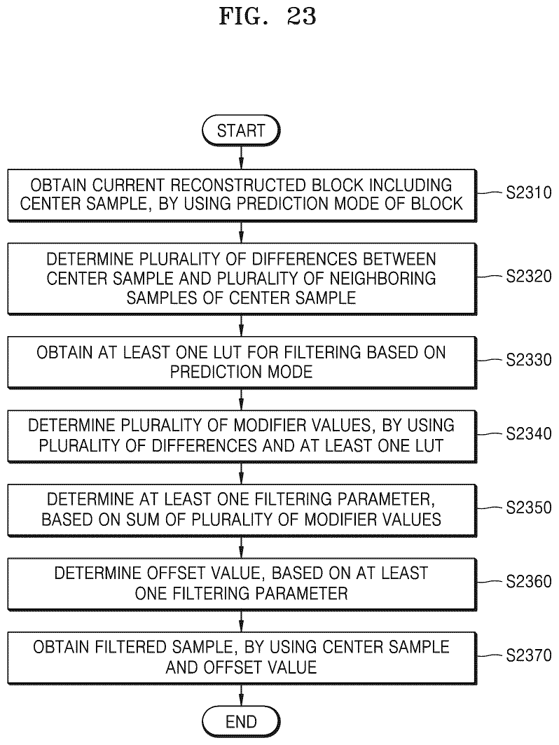

FIG. 23 is a flowchart illustrating an image decoding method according to an embodiment of the present disclosure.

Referring to FIG. 23, in operation S2310, the image decoding apparatus 2000 may obtain a current reconstructed block including a center sample by using a prediction mode of a block. According to an embodiment of the present disclosure, the current reconstructed block may include a block on which deblocking filtering has been performed.

In operation S2320, the image decoding apparatus 2000 may determine a plurality of differences between the center sample and a plurality of neighboring samples of the center sample. For example, the image decoding apparatus 2000 may determine a difference between the center sample and each of the neighboring samples. According to an embodiment of the present disclosure, the image decoding apparatus 2000 may determine a rounded difference between the center sample and the neighboring sample.

In operation S2330, the image decoding apparatus 2000 may obtain at least one LUT for filtering based on a prediction mode. According to an embodiment of the present disclosure, the image decoding apparatus 2000 may obtain at least one of a plurality of LUTs according to the prediction mode. For example, the image decoding apparatus 2000 may obtain a LUT corresponding to an IBC mode from among the plurality of LUTs based on the prediction mode being the IBC mode.

In operation S2340, the image decoding apparatus 2000 may determine a plurality of modifier values by using the plurality of differences and the at least one LUT. According to an embodiment of the present disclosure, the image decoding apparatus 2000 may obtain a modifier value of a LUT corresponding to each difference. For example, the image decoding apparatus 2000 may determine the difference as an index value of the LUT and obtain an output value of the LUT corresponding to the index value as the modifier value.

In operation S2350, the image decoding apparatus 2000 may determine at least one filtering parameter based on the sum of the plurality of modifier values. According to an embodiment of the present disclosure, the number of filtering parameters may be determined according to the prediction mode.

In operation S2360, the image decoding apparatus 2000 may determine an offset value based on the at least one filtering parameter. According to an embodiment of the present disclosure, the greater the filtering parameter, the greater the offset value. According to an embodiment of the present disclosure, the offset value may include a change amount of the current sample value according to filtering.

In operation S2370, the image decoding apparatus 2000 may obtain a filtered sample by using the center sample and the offset value. According to an embodiment of the present disclosure, the image decoding apparatus 2000 may perform adaptive loop filtering using the filtered sample.

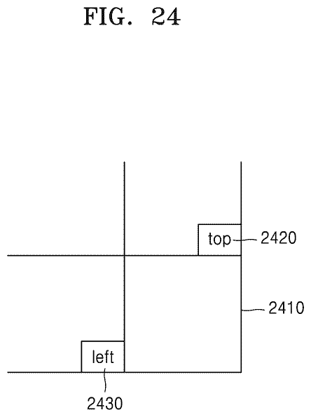

According to an embodiment of the present disclosure, the image decoding apparatus 2000 may perform filtering based on the prediction mode. A process for the image decoding apparatus 2000 to perform filtering according to the prediction mode will be described in detail with reference to FIGS. 24 to 33.

FIG. 24 is a diagram for describing filtering when a prediction mode indicates a combined inter intra prediction (CIIP) mode according to an embodiment of the present disclosure.

The image decoding apparatus 2000 may identify that a prediction mode of a block 2410 including a current sample indicates the CIIP mode. According to an embodiment of the present disclosure, the block 2410 may include coding units. The image decoding apparatus 2000 may determine a prediction mode of the block 2410 based on at least one of the number of samples included in the block 2410, the width of the block 2410, or the height of the block 2410. According to an embodiment of the present disclosure, the image decoding apparatus 2000 may obtain a flag with respect to the CIIP mode. For example, when the number of samples included in block 2410 is more than 64, and both the width of block 2410 and the height of block 2410 are less than 128, the image decoding apparatus 2000 may obtain the flag with respect to the CIIP mode. The flag with respect to the CIIP mode may be a flag indicating whether the CIIP prediction is applied to the block 2410.

When the prediction mode indicates the CIIP mode, the image decoding apparatus 2000 may perform prediction by combining inter prediction and intra prediction. The image decoding apparatus 2000 may perform intra prediction using a planar mode. The image decoding apparatus 2000 may obtain a prediction sample with respect to the CIIP mode through a weighted sum of a prediction sample by inter prediction and a prediction sample by intra prediction. For example, a prediction sample P_{CIIP} by CIIP may be determined as ((4−w)*Pᵢₙₜₑᵣ+w*Pᵢₙₜᵣₐ)>>2. A weight w may be determined based on prediction modes of an above neighboring location 2420 and a left neighboring location 2430. For example, when intra prediction is performed on both the above neighboring location 2420 and the left neighboring location 2430, the weight w may be determined as 3. The more intra predictions of neighboring locations, the greater the weight for intra prediction. For example, when intra prediction is not performed on both the upper neighboring location 2420 and the left neighboring location 2430, the weight w may be determined to be 1.

According to an embodiment of the present disclosure, when the prediction mode indicates the CIIP mode, the image decoding apparatus 2000 may obtain at least one of an inter LUT corresponding to inter prediction mode, an intra LUT corresponding to intra prediction mode, or a LUT predetermined according to the CIIP mode.

According to an embodiment of the present disclosure, the image decoding apparatus 2000 may perform filtering by combining filtering according to inter prediction and filtering according to intra prediction. According to an embodiment of the present disclosure, the image decoding apparatus 2000 may obtain a CIIP filtering parameter through a weighted sum of an inter filtering parameter according to inter prediction and an intra filtering parameter according to intra prediction. For example, the image decoding apparatus 2000 may determine the CIIP filtering parameter as shown in Equation 6.

BIF_{CIIP}=((4−w)*BIFᵢₙₜₑᵣ+w*BIFᵢₙₜᵣₐ)>>2 [Equation 6]

Here, BIF_{X} denotes a filtering parameter with respect to a prediction mode X. When the intra filtering parameter is determined as shown in Equation 6, the effect of high image quality improvement may be obtained by reflecting the characteristics of the CIIP mode well. According to an embodiment of the present disclosure, the weight may be the same as a determination condition of CIIP. For example, the weight w may be determined based on the prediction modes of the above neighboring location 2420 and the left neighboring location 2430.

According to an embodiment of the present disclosure, the image decoding apparatus 2000 may determine the CIIP filtering parameter through an average of the inter filtering parameter according to inter prediction and the intra filtering parameter according to intra prediction. When the CIIP filtering parameter is determined through the average of the inter filtering parameter and the intra filtering parameter, characteristics of both inter prediction and intra prediction may be considered while saving time and resources compared to determining the filtering parameter through the weighted sum.

According to an embodiment of the present disclosure, the image decoding apparatus 2000 may obtain an inter LUT corresponding to inter prediction and an intra LUT corresponding to intra prediction. The image decoding apparatus 2000 may obtain the inter filtering parameter according to the inter LUT. The image decoding apparatus 2000 may obtain the intra filtering parameter according to the intra LUT. The image decoding apparatus 2000 may determine the CIIP filtering parameter based on the inter filtering parameter and the intra filtering parameter. The image decoding apparatus 2000 may determine an offset value based on the CIP filtering parameter. According to an embodiment of the present disclosure, a process for the image decoding apparatus 2000 to determine the offset value by using the LUT has been described above, and thus, a description thereof is not provided here.

According to an embodiment of the present disclosure, the image decoding apparatus 2000 may obtain a filtering parameter of a reference block. For example, the image decoding apparatus 2000 may determine the filtering parameter of the reference block which is referred to in inter prediction as the inter filtering parameter.

According to an embodiment of the present disclosure, the image decoding apparatus 2000 may obtain a LUT predetermined according to CIIP. The CIIP LUT may be predetermined separately from the inter LUT and the intra LUT.

According to an embodiment of the present disclosure, the CIIP LUT may be obtained through a linear combination (or weighted sum) of the inter LUT and the intra LUT. Linear coefficients (or weights) with respect to the inter LUT and the intra LUT may be predetermined values.

According to an embodiment of the present disclosure, the CIIP LUT may have a distribution of output values corresponding to a linear, logistic, or sinusoidal below a certain index value, and have a value of 0 above the certain index value. For example, the CIIP LUT may be {1, 2, 3, 4, 5, 0, 0} with a linear distribution of output values below a certain index value of 4.

According to an embodiment of the present disclosure, the CIIP LUT may be determined as a linear combination with respect to a plurality of LUTs. For example, when a first LUT, a second LUT, and a third LUT respectively indicate the linear distribution, logistic distribution, and sinusoidal distribution equal to or less than a certain index value, the CIIP LUT may be determined through the weighted sum of the first LUT, the second LUT, or the third LUT. Weights between the plurality of LUTs may be experimentally predetermined values.

According to an embodiment of the present disclosure, the image decoding apparatus 2000 may obtain, from a bitstream, information about bilateral filtering applied to the block. For example, the image decoding apparatus 2000 may obtain, from the bitstream, information about a method of determining a CIIP filtering parameter. The information about the method of determining the CIIP filtering parameter may include index information indicating a type of a LUT. For example, the information about the method of determining the CIIP filtering parameter may include index information indicating at least one of i) whether the CIIP filtering parameter is determined through the weighted sum of inter filtering parameter and intra filtering parameter, ii) whether the CIIP filtering parameter is determined through the average of inter filtering parameter and intra filtering parameter, or iii) whether the CIIP filtering parameter is determined using the LUT predetermined with respect to the CIIP mode. The information about bilateral filtering may be determined in a coding unit, a largest coding unit, a slice unit, or a picture unit and transmitted through the bitstream.

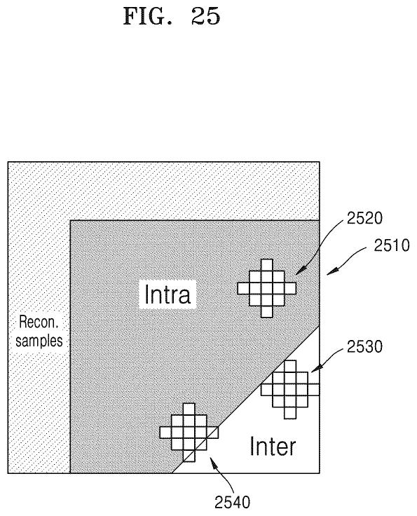

FIG. 25 is a diagram for describing filtering when a prediction mode indicates a GPM mode according to an embodiment of the present disclosure.

The image decoding apparatus 2000 may identify that a prediction mode of a block 2510 including a current sample indicates the GPM mode. According to an embodiment of the present disclosure, the block 2510 may include coding units. When the prediction mode is the GPM, the image decoding apparatus 2000 may split the block into a plurality of areas. The image decoding apparatus 2000 may determine a split boundary based on a distance and an angle to the split boundary. According to an embodiment of the present disclosure, the image decoding apparatus 2000 may determine prediction modes with respect to the split areas in the block 2510. The image decoding apparatus 2000 may obtain, from a bitstream, prediction mode information about the areas. Image

According to an embodiment of the present disclosure, the prediction mode of the block 2510 may include an inter prediction mode and an intra prediction mode. Inter prediction may be performed on one split area of the block 2510, and intra prediction may be performed on the other areas. According to an embodiment of the present disclosure, the block 2510 may be split into a first area on which intra prediction is performed and a second area on which inter prediction is performed.

According to an embodiment of the present disclosure, when the prediction mode indicates the GPM mode, the image decoding apparatus 2000 may obtain at least one of an inter LUT corresponding to an inter prediction mode, an intra LUT corresponding to an intra prediction mode, or a LUT predetermined according to a GPM prediction mode.

According to an embodiment of the present disclosure, the image decoding apparatus 2000 may perform filtering based on locations of a center sample and a neighboring sample. The image decoding apparatus 2000 may determine a split area of the block 2510 including the locations of the center sample and the neighboring sample.

According to an embodiment of the present disclosure, a filtering area 2520 of the image decoding apparatus 2000 including the center sample and the neighboring sample may be included in the first area on which intra prediction is performed. According to an embodiment of the present disclosure, when the filtering area 2520 is entirely included in the first area, the image decoding apparatus 2000 may determine a filtering parameter of intra prediction mode by using the intra LUT. For example, the image decoding apparatus 2000 may determine a filtering parameter of the prediction mode in the same manner as in intra prediction mode. According to an embodiment of the present disclosure, when the filtering area 2520 is entirely included in the first area, the image decoding apparatus 2000 may determine the filtering parameter of the prediction mode by obtaining the intra filtering parameter. For example, the image decoding apparatus 2000 may obtain a filtering parameter from a sample which is referred to in prediction of the center sample, and determine the obtained filtering parameter as the filtering parameter of the prediction mode.

According to an embodiment of the present disclosure, a filtering area 2530 of the image decoding apparatus 2000 including the center sample and the neighboring sample may be included in the second area on which inter prediction is performed. According to an embodiment of the present disclosure, when the filtering area 2530 is entirely included in the second area, the image decoding apparatus 2000 may determine a filtering parameter of the prediction mode by using the inter LUT. For example, the image decoding apparatus 2000 may determine the filtering parameter of the prediction mode in the same manner as in inter prediction mode. According to an embodiment of the present disclosure, when the filtering area 2530 is included in the second area, the image decoding apparatus 2000 may determine the filtering parameter of the prediction mode by obtaining the inter filtering parameter. For example, the image decoding apparatus 2000 may obtain a filtering parameter from the sample which is referred to in prediction of the center sample, and determine the obtained filtering parameter as the filtering parameter of the prediction mode.

According to an embodiment of the present disclosure, a filtering area 2540 of the image decoding apparatus 2000 including the center sample and the neighboring sample may be located at a boundary between the first area on which intra prediction is performed and the second area on which inter prediction is performed. That is, a part of the filtering area 2540 may be included in the first area, and the remaining part may be included in the second area. According to an embodiment of the present disclosure, when the filtering area is located at the boundary of the first area and the second area, the image decoding apparatus 2000 may determine the filtering parameter of the prediction mode by using at least one of the inter LUT, the intra LUT, a CIIP LUT, or a LUT predetermined according to the GPM. According to an embodiment of the present disclosure, the image decoding apparatus 2000 may obtain the inter LUT corresponding to inter prediction and the intra LUT corresponding to intra prediction. The image decoding apparatus 2000 may obtain an inter filtering parameter according to the inter LUT. The image decoding apparatus 2000 may obtain an intra filtering parameter according to the intra LUT. The image decoding apparatus 2000 may obtain a GPM filtering parameter according to the GPM LUT. The image decoding apparatus 2000 may determine the GPM filtering parameter based on a CHIP filtering parameter. The image decoding apparatus 2000 may determine an offset value based on the GPM filtering parameter. According to an embodiment of the present disclosure, a process for the image decoding apparatus 2000 to determine the offset value by using the LUT has been described above, and thus, a description thereof is not provided here.

According to an embodiment of the present disclosure, the image decoding apparatus 2000 may determine the GPM filtering parameter by using the CIIP filtering parameter. The image decoding apparatus 2000 may determine the filtering parameter by using the process of determining a filtering parameter described with reference to FIG. 24. According to an embodiment of the present disclosure, the image decoding apparatus 2000 may determine a filtering parameter by using the CIIP LUT.

According to an embodiment of the present disclosure, the image decoding apparatus 2000 may determine a filtering parameter by using the inter LUT determined according to inter prediction mode and the intra LUT determined according to intra prediction mode. The image decoding apparatus 2000 may determine the GPM filtering parameter through the weighted sum of the inter filtering parameter and the intra filtering parameter. A weight may be determined based on the number of samples included in an inter mode area of the block 2510 and the number of samples included in an intra mode area. For example, the weight may be determined based on a ratio of the number of samples predicted according to the inter mode and the number of samples predicted according to the intra mode from among samples included in the block 2510. For example, the GPM filtering parameter may be determined as shown in Equation 7.

BIF_{GPM}=(nᵢₙₜₑᵣ*BIFᵢₙₜₑᵣ+nᵢₙₜᵣₐ*BIFᵢₙₜᵣₐ)>>(log 2(nᵢₙₜₑᵣ+nᵢₙₜᵣₐ)) [Equation 7]

Here, nᵢₙₜₑᵣ denotes the number of samples included in the inter mode area of the block, and nᵢₙₜᵣₐ denotes the number of samples included in the intra mode area of the block.

According to an embodiment of the present disclosure, the image decoding apparatus 2000 may determine a filtering parameter by using the LUT predetermined according to the GPM.

According to an embodiment of the present disclosure, the image decoding apparatus 2000 may determine a filtering parameter based on locations of the filtering areas 2520, 2530, and 2540. According to an embodiment of the present disclosure, when the filtering area 2520 is entirely included in the first area, the image decoding apparatus 2000 may determine a filtering parameter of intra prediction mode by using the intra LUT. According to an embodiment of the present disclosure, when the filtering area 2520 is entirely included in the first area, the image decoding apparatus 2000 may determine the filtering parameter of the prediction mode by obtaining the intra filtering parameter.

According to an embodiment of the present disclosure, when f the filtering areas 2530 is entirely included in the second area, the image decoding apparatus 2000 may determine the filtering parameter of the prediction mode by using the inter LUT. For example, the image decoding apparatus 2000 may determine the filtering parameter of the prediction mode in the same manner as in inter prediction mode. According to an embodiment of the present disclosure, when the filtering area 2530 is included in the second area, the image decoding apparatus 2000 may determine the filtering parameter of the prediction mode by obtaining the inter filtering parameter.

According to an embodiment of the present disclosure, when the filtering area 2530 is located at the boundary of the first area and the second area, the image decoding apparatus 2000 may determine a filtering parameter by using the inter LUT determined according to inter prediction mode and the intra LUT determined according to intra prediction mode. The image decoding apparatus 2000 may determine the GPM filtering parameter through the weighted sum of the inter filtering parameter and the intra filtering parameter. The weight may be determined based on the number of samples included in the inter mode area of the block 2510 and the number of samples included in the intra mode area. For example, the GPM filtering parameter may be determined as shown in Equation 7.

According to an embodiment of the present disclosure, when the location of the filtering area 2540 is a boundary between the first area and the second area, the image decoding apparatus 2000 may determine a filtering parameter by using a LUT predetermined according to the GPM. When the location of the filtering area 2520 is the first area or the location of the filtering area 2540 is the second area, the image decoding apparatus 2000 may determine each of the inter filtering parameter and the intra filtering parameter as the GPM filtering parameter.

According to an embodiment of the present disclosure, the image decoding apparatus 2000 may determine a filtering parameter by using the LUT predetermined according to the GPM regardless of the location of a filtering area. For example, even when the location of the filtering area 2520 is the first area or the location of the filtering area 2540 is the second area, the image decoding apparatus 2000 may determine the filtering parameter by using the LUT predetermined according to the GPM.

According to an embodiment of the present disclosure, the image decoding apparatus 2000 may obtain, from a bitstream, information about bilateral filtering applied to the block. For example, the image decoding apparatus 2000 may obtain, from the bitstream, information about a method of determining the GPM filtering parameter. The information about the method of determining the GPM filtering parameter may include index information indicating a type of a LUT. For example, the information about the method of determining the GPM filtering parameter may include index information indicating at least one of i) whether the GPM filtering parameter is determined as the CIIP filtering parameter, ii) whether the GPM filtering parameter is determined through the weighted sum of inter filtering parameter and intra filtering parameter, or iii) whether the GPM mode filtering parameter is determined using the LUT predetermined with respect to the GPM. The information about bilateral filtering may be determined in a coding unit, a largest coding unit, a slice unit, or a picture unit and transmitted through the bitstream.

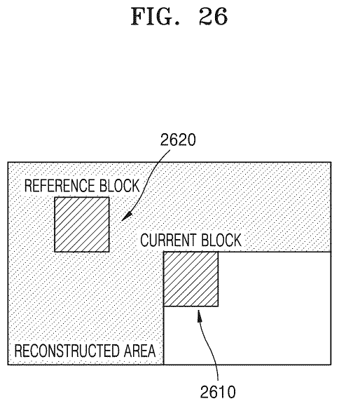

FIG. 26 is a diagram for describing filtering when a prediction mode indicates an IBC mode according to an embodiment of the present disclosure.

The image decoding apparatus 2000 may identify that a prediction mode of a current block 2610 including a current sample indicates an IBC mode. According to an embodiment of the present disclosure, the current block 2610 may include a coding unit.

According to an embodiment of the present disclosure, the image decoding apparatus 2000 may determine a reference block 2620 when the prediction mode of the current block 2610 is the IBC. For example, the image decoding apparatus 2000 may determine the reference block 2620 from vector information indicating the reference block 2620. The image decoding apparatus 2000 may predict the current block 2610 based on the reference block 2620. For example, the image decoding apparatus 2000 may predict the current block 2610 in the same manner as the reference block 2620.

According to an embodiment of the present disclosure, when the prediction mode indicates the IBC mode, the image decoding apparatus 2000 may obtain at least one of a reference LUT corresponding to the reference block 2620 or a LUT predetermined according to the IBC mode.

According to an embodiment of the present disclosure, the image decoding apparatus 2000 may perform filtering according to the IBC mode. According to an embodiment of the present disclosure, the IBC mode may include at least one of IBC merge, IBC AMVP, IBC-TM merge, IBC-TM AMVP, IBC-CIIP, or IBC-GPM.

According to an embodiment of the present disclosure, the image decoding apparatus 2000 may obtain a filtering parameter of the reference block 2620. The image decoding apparatus 2000 may determine the filtering parameter of the reference block 2620 as a filtering parameter of the current block 2610.

According to an embodiment of the present disclosure, the image decoding apparatus 2000 may obtain the LUT of the reference block 2620. The image decoding apparatus 2000 may determine the LUT of the reference block 2620 as a LUT of the current block 2610. The image decoding apparatus 2000 may determine the filtering parameter of the current block 2610 by using the determined LUT.

According to an embodiment of the present disclosure, the image decoding apparatus 2000 may obtain the LUT predetermined according to the IBC mode. The IBC LUT may be predetermined separately from an inter LUT and an intra LUT. The image decoding apparatus 2000 may determine an offset value by using the IBC LUT. A process for the image decoding apparatus 2000 to determine the offset value by using the LUT has been described above, and thus, a description thereof is not provided here.

According to an embodiment of the present disclosure, the image decoding apparatus 2000 may obtain, from a bitstream, information about bilateral filtering applied to a block. For example, the image decoding apparatus 2000 may obtain, from the bitstream, information about a method of determining an IBC filtering parameter. The information about the method of determining the IBC filtering parameter may include index information indicating a type of a LUT. For example, the information about the method of determining the IBC filtering parameter may include index information indicating at least one of i) whether the IBC filtering parameter is determined as a filtering parameter of a reference block, or ii) whether the IBC filtering parameter is determined using a LUT predetermined with respect to the IBC mode. The information about bilateral filtering may be determined in a coding unit, a largest coding unit, a slice unit, or a picture unit and transmitted through the bitstream.

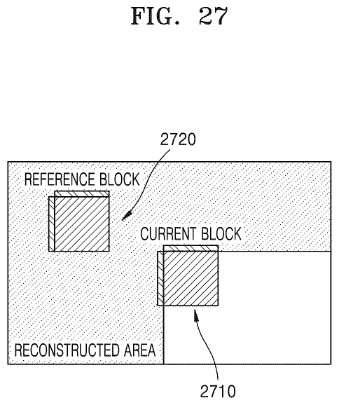

FIG. 27 is a diagram for describing filtering when a prediction mode indicates a template matching prediction mode according to an embodiment of the present disclosure.

The image decoding apparatus 2000 may identify that a prediction mode of a current block 2710 including a current sample indicates a template matching mode. According to an embodiment of the present disclosure, the current block 2710 may include a coding unit.

According to an embodiment of the present disclosure, the image decoding apparatus 2000 may determine a reference block 2720 in the template matching mode of the current block 2710. For example, the image decoding apparatus 2000 may determine a template area similar to a template area of the current block 2710 and determine the reference block 2720 corresponding to the determined template area. The image decoding apparatus 2000 may predict the current block 2710 based on the reference block 2720. For example, the image decoding apparatus 2000 may predict the current block 2710 in the same manner as the reference block 2720.

According to an embodiment of the present disclosure, when the prediction mode indicates the template matching mode, the image decoding apparatus 2000 may obtain at least one of a reference LUT corresponding to the reference block 2720 or a LUT predetermined according to the template matching mode.

According to an embodiment of the present disclosure, the image decoding apparatus 2000 may perform filtering according to the template matching mode.

According to an embodiment of the present disclosure, the image decoding apparatus 2000 may obtain a filtering parameter of the reference block 2720. The image decoding apparatus 2000 may determine the filtering parameter of the reference block 2720 as a filtering parameter of the current block 2710.

According to an embodiment of the present disclosure, the image decoding apparatus 2000 may obtain a LUT of the reference block 2720. The image decoding apparatus 2000 may determine the LUT of the reference block 2720 as the LUT of the current block 2710. The image decoding apparatus 2000 may determine a filtering parameter of the current block 2710 by using the determined LUT.

According to an embodiment of the present disclosure, the image decoding apparatus 2000 may obtain the LUT predetermined according to the template matching mode. The template matching LUT may be predetermined separately from an inter LUT and an intra LUT. The image decoding apparatus 2000 may determine an offset value by using the template matching LUT. A process for the image decoding apparatus 2000 to determine an offset value by using the LUT has been described above, and thus, a description thereof is not provided here.

According to an embodiment of the present disclosure, the image decoding apparatus 2000 may predict the current block 2720 by using a plurality of reference blocks 2720. For example, the image decoding apparatus 2000 may predict the current block 2720 through the weighted sum of the plurality of reference blocks 2720. The image decoding apparatus 2000 may determine the filtering parameter of the current block through the weighted sum of filtering parameters of the plurality of reference blocks 2720. Weights with respect to the plurality of reference blocks 2720 in the filtering operation may be the same as weights with respect to the plurality of reference blocks 2720 in the prediction operation.

According to an embodiment of the present disclosure, the image decoding apparatus 2000 may obtain, from a bitstream, information about bilateral filtering applied to a block. For example, the image decoding apparatus 2000 may obtain, from the bitstream, information about a method of determining the template matching filtering parameter. The information about the method of determining the template matching filtering parameter may include index information indicating a type of a LUT. For example, the information about the method of determining the template matching filtering parameter may include index information indicating at least one of i) whether the template matching filtering parameter is determined as a filtering parameter of a reference block, or ii) whether the template matching filtering parameter is determined using a LUT predetermined with respect to the template matching mode. The information about bilateral filtering may be determined in a coding unit, a largest coding unit, a slice unit, or a picture unit and transmitted through the bitstream.

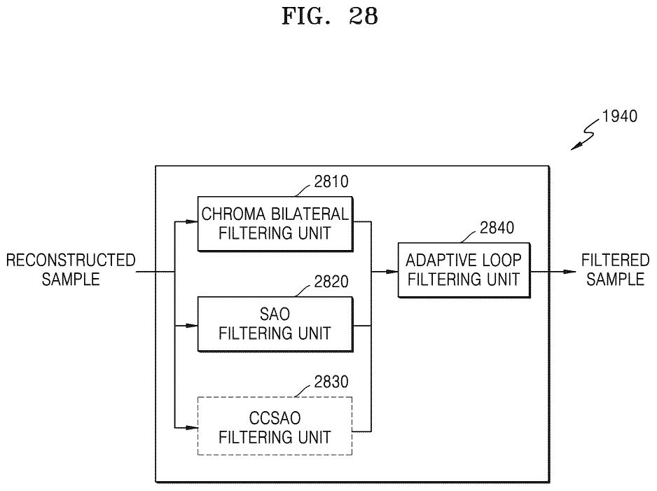

FIG. 28 is a block diagram illustrating components of a loop filtering unit according to an embodiment of the present disclosure.

Referring to FIG. 28, the loop filtering unit 1940 may generate a filtered sample by performing filtering a reconstructed sample. According to an embodiment of the present disclosure, the loop filtering unit 1940 may perform filtering on a chroma sample. According to an embodiment of the present disclosure, the loop filtering unit 1940 may include a chroma bilateral filtering unit 2810, a SAO filtering unit 2820, and an adaptive loop filtering unit 2840.

According to an embodiment of the present disclosure, the chroma bilateral filtering unit 2810 may correspond to the bilateral filtering unit 2110. According to an embodiment of the present disclosure, the chroma bilateral filtering unit 2110 may perform filtering on a sample of a chroma component. According to an embodiment of the present disclosure, the SAO filtering unit 2820 may correspond to the SAO filtering unit 2120. According to an embodiment of the present disclosure, the adaptive loop filtering unit 2840 may correspond to the adaptive loop filtering unit 2130. The loop filtering unit 1940 may further include a cross component sample adaptive offset (CCSAO) filtering unit 2830.

The CCSAO filtering unit 2830 may determine a CCSAO offset value ΔI_{CCSAO} with respect to a current sample. The CCSAO filtering unit 2830 may determine a cross component offset. The CCSAO filtering unit 2830 may determine the CCSAO offset value ΔI_{CCSAO} by using a luma sample and the chroma sample.

According to an embodiment of the present disclosure, the chroma bilateral filtering unit 2810 may perform filtering on the current sample using neighboring samples of the current sample. The chroma bilateral filtering unit 2810 may perform filtering on the sample of the chroma component. The chroma bilateral filtering unit 2810 may determine a BIF offset value ΔI_{BIF} with respect to the current sample. The offset value may include a change amount of the current sample according to filtering. The chroma bilateral filtering unit 2810 may determine a filtering intensity based on differences between the current sample and the neighboring samples. For example, the chroma bilateral filtering unit 2810 may apply stronger filtering as a difference between the current sample and the neighboring sample increases. That is, the chroma bilateral filtering unit 2810 may have a large difference of the current sample before and after filtering.

According to an embodiment of the present disclosure, the chroma bilateral filtering unit 2810 may determine an offset value by using a LUT corresponding to a chroma. The chroma bilateral filtering unit 2810 may obtain a LUT according to a color component.

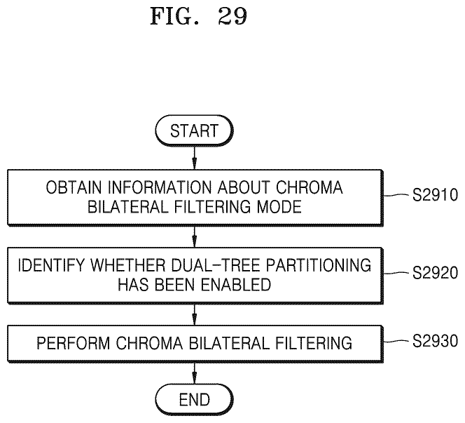

According to an embodiment of the present disclosure, the chroma bilateral filtering unit 2810 may perform filtering on the chroma sample based on a reconstructed luma sample. The chroma bilateral filtering unit 2810 may determine a LUT applied to filtering of the chroma sample based on the luma sample. A process of filtering the chroma sample based on the reconstructed luma sample according to an embodiment of the present disclosure will be described in detail with reference to FIGS. 29 to 32.

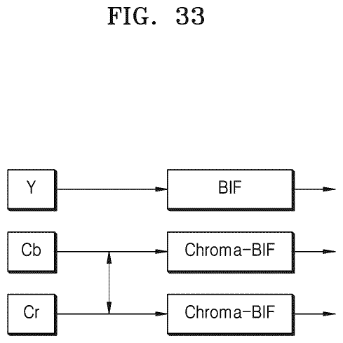

According to an embodiment of the present disclosure, the chroma bilateral filtering unit 2810 may perform filtering on a first chroma sample based on a reconstructed second chroma sample. The chroma bilateral filtering unit 2810 may determine a LUT applied to filtering of the first chroma sample based on the second chroma sample. A process of filtering the first chroma sample based on the reconstructed second chroma sample according to an embodiment of the present disclosure will be described in detail with reference to FIG. 33.

According to an embodiment of the present disclosure, a filtered current sample may be determined using the BIF offset value determined by the chroma bilateral filtering unit 2810, the SAO offset value determined by the SAO filtering unit 2820, and the CCSAO offset value determined by the CCSAO filtering unit 2830. For example, the filtered current sample may be determined through the sum of the reconstructed current sample, BIF offset value, SAO offset value, and CCSAO offset value. The filtered current sample may not be greater than a bit depth of an image.

According to an embodiment of the present disclosure, the loop filtering unit 1940 may not include at least some of the chroma bilateral filtering unit 2810, the SAO filtering unit 2820, the CCSAO filtering unit 2830, and the adaptive loop filtering unit 2840. For example, only bilateral filtering may be performed on the reconstructed sample by the chroma bilateral filtering unit 2810. Whether the chroma bilateral filtering unit 2810, the SAO filtering unit 2820, the CCSAO filtering unit 2830, and the adaptive loop filtering unit 2840 perform filtering may be obtained through a bitstream. Whether the chroma bilateral filtering unit 2810, the SAO filtering unit 2820, and the CCSAO filtering unit 2830 perform filtering may be determined using an RDO. That is, whether to apply filtering may be determined through an optimization process using the quality of the image and the number of bits included in the bitstream.

The image decoding apparatus 2000 may obtain, from the bitstream, information indicating whether to perform filtering. The image decoding apparatus 2000 may perform filtering based on the obtained information. According to an embodiment of the present disclosure, the bilateral filtering unit 2810, the SAO filtering unit 2820, and the CCSAO filtering unit 2830 may be sequentially performed without being performed in parallel.

According to an embodiment of the present disclosure, the loop filtering unit 1970 may be configured to be the same as the loop filtering unit 1940. The loop filtering unit 1970 may include a bilateral filtering unit, a SAO filtering unit, and/or an adaptive loop filtering unit.

FIG. 29 is a flowchart illustrating an image decoding method according to an embodiment of the present disclosure.

Referring to FIG. 29, in operation S2910, the image decoding apparatus 2000 may obtain information about a chroma bilateral filtering mode. For example, the image decoding apparatus 2000 may obtain, from a bitstream, information about a method of determining a LUT used in chroma bilateral filtering. The information about the method of determining the LUT may include index information indicating a method of determining the LUT. For example, the information about the method of determining the LUT may include index information indicating at least one of i) a mode of determining a LUT by using a luma center sample, ii) a mode of determining a LUT by using a BIF offset value of the luma center sample, iii) a mode of determining a LUT by using a filtered luma center sample, or iv) a mode of determining a LUT by using a chroma center sample. Information about bilateral filtering may be determined in a coding unit, a largest coding unit, a slice unit, or a picture unit and transmitted through the bitstream. According to an embodiment of the present disclosure, operation S2910 may be omitted. When operation S2910 is omitted, the LUT may be determined using a predetermined mode.

In operation S2920, the image decoding apparatus 2000 may identify whether dual-tree partitioning has been enabled. According to an embodiment of the present disclosure, the image decoding apparatus 2000 may determine a LUT based on whether dual-tree partitioning has been enabled. When dual-tree partitioning has been enabled, the image decoding apparatus 2000 may obtain a LUT predetermined according to dual-tree partitioning. According to an embodiment of the present disclosure, operation S2920 may be omitted. When operation S2920 is omitted, a predetermined LUT may be obtained.

In operation S2930, the image decoding apparatus 2000 may perform chroma bilateral filtering. The image decoding apparatus 2000 may perform chroma bilateral filtering using a LUT. A process for the image decoding apparatus 2000 to perform bilateral filtering has been described, and thus, a description thereof is not provided here.

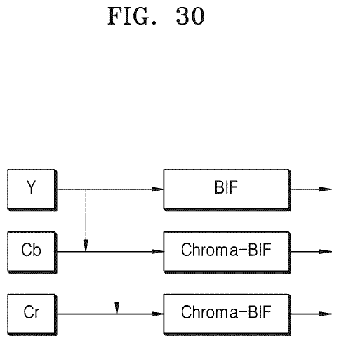

FIG. 30 is a diagram for describing a chroma BIF according to an embodiment of the present disclosure.

Referring to FIG. 30, bilateral filtering on a chroma sample may be performed using a luma sample. According to an embodiment of the present disclosure, the chroma sample may include at least one of a sample of a Cb component or a sample of a Cr component.

According to an embodiment of the present disclosure, the image decoding apparatus 2000 may determine a LUT for the chroma sample by using a reconstructed luma sample. The image decoding apparatus 2000 may determine a center luma sample corresponding to a current chroma sample for performing filtering. The image decoding apparatus 2000 may determine differences between a center luma sample and neighboring luma samples.

According to an embodiment of the present disclosure, the neighboring luma sample may be a sample adjacent to the center luma sample, and may exhibit a shape of one of a 3×3 cross, 3×3 square, 3×3 diamond, or 5×5 diamond. When the shape of the neighboring luma sample is the 3×3 cross, the neighboring luma sample may include samples located at above left, below left, below right, and above right of the center luma sample. When the shape of the neighboring luma sample is the 3×3 square, the neighboring luma sample may include samples located at above left, left, below left, below, below right, right, above right, and above of the center luma sample. When the shape of the neighboring luma sample is the 3×3 diamond, the neighboring luma sample may include samples located at left, below, right, and above of the center luma sample. When the shape of the neighboring luma sample is the 5×5 diamond, the neighboring luma sample may include 12 samples as described with reference to FIG. 22.

According to an embodiment of the present disclosure, the image decoding apparatus 2000 may determine the differences between the center luma sample and the neighboring luma samples by down-sampling a luma block. For example, when a color format is 4:2:2, the image decoding apparatus 2000 may downscale the luma block two times and determine differences between a center luma sample of the downscaled luma block and neighboring luma samples. For example, when the color format is 4:2:0, the image decoding apparatus 2000 may downscale the luma block four times and determine differences between a center luma sample of the downscaled luma block and neighboring luma samples. The image decoding apparatus 2000 may determine the differences between the center luma sample and the neighboring luma samples without performing downsampling on the luma block. For example, the image decoding apparatus 2000 may not perform downscaling when the color format is 4:4:4. The image decoding apparatus 2000 may not perform downscaling even when the color format is 4:2:2.

According to an embodiment of the present disclosure, the image decoding apparatus 2000 may determine a LUT for filtering the chroma sample by using the difference. For example, the image decoding apparatus 2000 may determine a chroma LUT of a chroma component by using the luma center sample and a plurality of neighboring samples of the luma center sample. The image decoding apparatus 2000 may determine an average or weighted sum of differences between the center luma sample and the neighboring luma samples. The image decoding apparatus 2000 may determine a LUT corresponding to the average or weighted sum of the differences. According to an embodiment of the present disclosure, the average or weighted sum of the differences may be quantized to be included in a certain range. For example, the average or weighted sum of the differences may be quantized to have one of 0 to k−1.

According to an embodiment of the present disclosure, the image decoding apparatus 2000 may perform bilateral filtering on the chroma sample using the determined LUT. The image decoding apparatus 2000 may determine differences between the current chroma sample and neighboring samples of the current chroma sample. The image decoding apparatus 2000 may determine modifier values corresponding to the differences by using the determined LUT. The image decoding apparatus 2000 may determine a filtering parameter by using the modifier values. The image decoding apparatus 2000 may determine an offset value by using the filtering parameter.

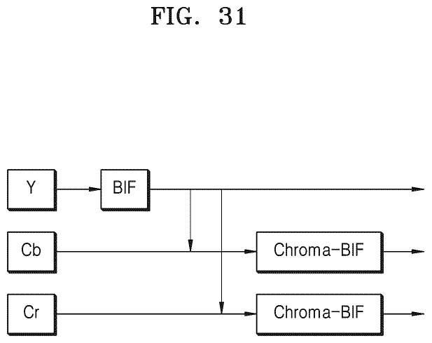

FIG. 31 is a diagram for describing a chroma BIF according to an embodiment of the present disclosure.

Referring to FIG. 31, bilateral filtering on a chroma sample may be performed using a BIF offset value of a luma sample. According to an embodiment of the present disclosure, the chroma sample may include at least one of a sample of a Cb component or a sample of a Cr component.

The image decoding apparatus 2000 may determine a luma sample corresponding to a current chroma sample for performing filtering. According to an embodiment of the present disclosure, the image decoding apparatus 2000 may obtain the BIF offset value of the luma sample. The image decoding apparatus 2000 may determine a LUT for the chroma sample by using the BIF offset value of the luma sample. For example, the image decoding apparatus 2000 may determine a chroma LUT of a chroma component based on at least one of an offset value with respect to a luma center sample or a filtered luma center sample.

According to an embodiment of the present disclosure, the BIF offset value may be quantized to be included in a certain range. For example, the BIF offset value may be quantized to have one of 0 to k−1. The image decoding apparatus 2000 may obtain a LUT corresponding to the quantized BIF offset value.

According to an embodiment of the present disclosure, the image decoding apparatus 2000 may perform bilateral filtering on the chroma sample using the determined LUT. The image decoding apparatus 2000 may determine a chroma filtering parameter based on the LUT. The image decoding apparatus 2000 may determine differences between the current chroma sample and neighboring samples of the current chroma sample. The image decoding apparatus 2000 may determine modifier values corresponding to the differences by using the determined LUT. The image decoding apparatus 2000 may determine a filtering parameter by using the modifier values. The image decoding apparatus 2000 may determine an offset value by using the filtering parameter.

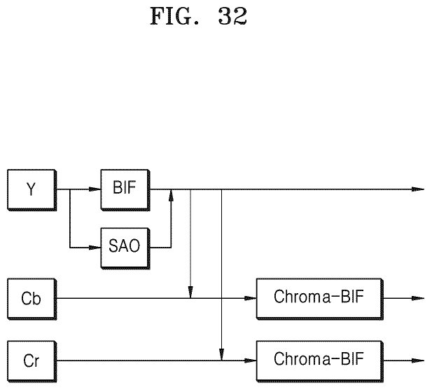

FIG. 32 is a diagram for describing a chroma BIF according to an embodiment of the present disclosure.

Referring to FIG. 32, bilateral filtering on a chroma sample may be performed using a luma sample on which BIF filtering has been performed. The image decoding apparatus 2000 may perform bilateral filtering on the chroma sample using the luma sample on which at least one of BIF filtering or SAO filtering has been performed. According to an embodiment of the present disclosure, the chroma sample may include at least one of a sample of a Cb component or a sample of a Cr component.

The image decoding apparatus 2000 may determine a luma sample corresponding to a current chroma sample for performing filtering. According to an embodiment of the present disclosure, the image decoding apparatus 2000 may obtain a BIF offset value of the luma sample. According to an embodiment of the present disclosure, the image decoding apparatus 2000 may obtain a SAO offset value of the luma sample. The image decoding apparatus 2000 may obtain a filtered luma sample by using at least one of the BIF offset value or the SAO offset value of the luma sample.

The image decoding apparatus 2000 may determine a LUT for the chroma sample by using the filtered luma sample. For example, the image decoding apparatus 2000 may determine a chroma LUT of a chroma component based on at least one of an offset value with respect to a luma center sample or a filtered luma center sample. The image decoding apparatus 2000 may determine a difference between the filtered luma sample and the center luma sample. According to an embodiment of the present disclosure, the difference between the filtered luma sample and the center luma sample may be quantized to be included in a certain range. For example, the difference between the filtered luma sample and the center luma sample may be quantized to have one of 0 to k−1. The image decoding apparatus 2000 may obtain a LUT corresponding to the quantized difference.

According to an embodiment of the present disclosure, the image decoding apparatus 2000 may perform bilateral filtering on the chroma sample using the determined LUT. The image decoding apparatus 2000 may determine differences between the current chroma sample and neighboring samples of the current chroma sample. The image decoding apparatus 2000 may determine modifier values corresponding to the differences by using the determined LUT. The image decoding apparatus 2000 may determine a filtering parameter by using the modifier values. The image decoding apparatus 2000 may determine an offset value by using the filtering parameter.

FIG. 33 is a diagram for describing a chroma BIF according to an embodiment of the present disclosure.

Referring to FIG. 33, bilateral filtering of a chroma sample may be performed using another chroma sample. According to an embodiment of the present disclosure, the chroma sample may include at least one of a sample of a Cb component or a sample of a Cr component. Bilateral filtering on the Cb sample may be performed using the Cr sample.

According to an embodiment of the present disclosure, the image decoding apparatus 2000 may determine a LUT for a first chroma sample by using a reconstructed second chroma sample. The image decoding apparatus 2000 may determine a second chroma sample corresponding to a current second chroma sample for performing filtering. The image decoding apparatus 2000 may determine differences between the second chroma sample and neighboring samples of the second chroma sample.

According to an embodiment of the present disclosure, the neighboring sample of the second chroma sample is a sample adjacent to the second chroma sample, and may exhibit the shape of one of a 3×3 cross, 3×3 square, 3×3 diamond, or 5×5 diamond. When the shape of the neighboring sample of the second chroma sample is the 3×3 cross, the neighboring sample may include samples located at above left, below left, below right, and above right of the second chroma sample. When the shape of the neighboring sample of the second chroma sample is the 3×3 square, the neighboring sample may include samples located at above left, left, below left, below, below right, right, above right, and above of the second chroma sample. When the shape of the neighboring sample of the second chroma sample is the 3×3 diamond, the neighboring sample may include samples located at left, below, right, and above of the second chroma sample. When the shape of the neighboring sample of the second chroma sample is the 5×5 diamond, the neighboring sample may include 12 samples as described with reference to FIG. 22.

According to an embodiment of the present disclosure, the image decoding apparatus 2000 may determine a LUT for filtering the chroma sample by using the difference. The image decoding apparatus 2000 may determine an average or weighted sum of differences between the second chroma sample and the neighboring samples. The image decoding apparatus 2000 may determine a LUT corresponding to the average or weighted sum of the differences. According to an embodiment of the present disclosure, the average or weighted sum of the differences may be quantized to be included in a certain range. For example, the average or weighted sum of the differences may be quantized to have one of 0 to k−1.

According to an embodiment of the present disclosure, the image decoding apparatus 2000 may perform bilateral filtering on the first chroma sample using the determined LUT. The image decoding apparatus 2000 may determine differences between the first chroma sample and neighboring samples of the first chroma sample. The image decoding apparatus 2000 may determine modifier values corresponding to the differences by using the determined LUT. The image decoding apparatus 2000 may determine a filtering parameter by using the modifier values. The image decoding apparatus 2000 may determine an offset value by using the filtering parameter.

According to an embodiment of the present disclosure, the image decoding apparatus 2000 may determine a LUT for the second chroma sample by using the reconstructed first chroma sample. The image decoding apparatus 2000 may determine the LUT for the second chroma sample by using the first chroma sample in the same manner as the image decoding apparatus 2000 determines the LUT for the first chroma sample by using the second chroma sample. The image decoding apparatus 2000 may perform filtering on the second chroma sample using the LUT determined using the first chroma sample.

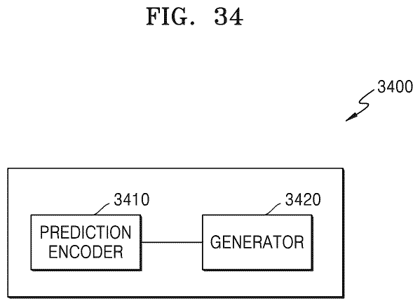

FIG. 34 is a block diagram illustrating components of an image encoding apparatus according to an embodiment of the present disclosure.

Referring to FIG. 34, an image encoding apparatus 3400 may include a prediction encoder 3410 and a generator 3420.

According to an embodiment of the present disclosure, the prediction encoder 3410 and the generator 3420 may be implemented as at least one processor. According to an embodiment of the present disclosure, the image encoding apparatus 3400 may include memory that stores input/output data of the prediction encoder 3410 and the generator 3420. The prediction encoder 3410 and the generator 3420 may operate according to instructions stored in the memory. According to an embodiment of the present disclosure, the image encoding apparatus 3400 may include a memory controller that controls data input/output of the memory.

According to an embodiment of the present disclosure, the prediction encoder 3410 may correspond to the prediction encoder 1915 shown in FIG. 19. According to an embodiment of the present disclosure, the generator 3420 may correspond to the entropy encoder 1925 shown in FIG. 19.

The prediction encoder 3410 may determine a prediction mode of a current block. The current block may include at least one of a largest coding unit, an encoding unit, a transformation unit, or a prediction unit that are split from a current image to be encoded. According to an embodiment of the present disclosure, a prediction mode of the current block may include an intra mode, an inter mode, a combined mode, a GPM, and/or an IBC. In an embodiment, the intra mode may include a template matching-based prediction mode. In an embodiment, a block copy mode may include an IBC mode. In an embodiment, the IBC mode may be a sub mode of the intra mode, but is not limited thereto, and may indicate a mode separate from the intra mode. In an embodiment, the template matching-based prediction mode may include a template matching-based intra prediction mode. The combined mode may include a CIIP mode in which prediction is performed by combining prediction according to the intra mode and prediction according to the inter mode. The GPM may include a splitting mode to have directionality in a block. The GPM may perform prediction using inter prediction or intra prediction with respect to each of split areas of the block.

According to an embodiment of the present disclosure, when the prediction mode of the current block is the CIIP mode, the prediction encoder 3410 may perform prediction on the current block by combining inter prediction and intra prediction. The prediction encoder 3410 may perform intra prediction according to a planar mode. The prediction encoder 3410 may determine a motion vector of a reference block with respect to the current block. The prediction encoder 3410 may perform inter prediction using the motion vector. The prediction encoder 3410 may predict the current block by using a weighted sum of a prediction block according to inter prediction and a prediction block according to intra prediction. A weight may be determined based on whether a block adjacent to the current block is intra predicted (or inter predicted).

According to an embodiment of the present disclosure, when the prediction mode of the current block is the GPM, the prediction encoder 3410 may perform prediction by splitting the current block. The prediction encoder 3410 may obtain a split angle and a split distance with respect to an edge on which splitting in the current block is performed. The prediction encoder 3410 may split the current block based on the split angle and the split distance. The prediction encoder 3410 may predict the current block by performing inter prediction or intra prediction on each of split areas in the current block. The prediction encoder 3410 may (i) perform intra prediction on both split areas, (ii) perform inter prediction on one area and intra prediction on the other area, or (iii) perform inter prediction on both split areas.

According to an embodiment of the present disclosure, when the prediction mode of the current block is the intra mode, the prediction encoder 3410 may determine an intra prediction mode of the current block.

According to an embodiment of the present disclosure, when the prediction mode of the current block is the block copy mode, the prediction encoder 3410 may determine information about a block vector indicating the reference block.

According to an embodiment of the present disclosure, the prediction encoder 3410 may perform intra prediction or inter prediction on the current block according to the prediction mode of the current block, and may encode the current block by using a prediction block generated as a result of performing intra prediction or inter prediction.

According to an embodiment of the present disclosure, when the prediction mode of the current block is the block copy mode, the prediction encoder 3410 may determine a prediction block from the reference block. For example, the prediction encoder 3410 may determine the prediction block to be same as the reference block or determine the prediction block by performing filtering on the reference block.

According to an embodiment of the present disclosure, when the prediction mode of the current block is the template matching prediction mode, the prediction encoder 3410 may reconstruct the current block by using the reference block. The prediction encoder 3410 may determine the prediction block by using the reference block.

The prediction encoder 3410 may perform deblocking filtering. A deblocking filter may improve image quality by smoothing an edge between blocks.

The prediction encoder 3410 may perform filtering on a sample of the current block on which deblocking filtering is performed, using a SAO filter and/or a BIF. The SAO filter and the BIF may improve the image quality by reducing an error between a reconstructed image and an original image. The SAO filter and the BIF may be filtered in a sample unit.

The prediction encoder 3410 may perform filtering using an ALF. The ALF may improve the image quality by reducing an error between a reconstructed image and an original image. The ALF may perform filtering in a block unit.

According to an embodiment of the present disclosure, encoding of the current block may mean a process of generating information that enables the image decoding apparatus 2000 to reconstruct the current block. The information generated through encoding may be included in a bitstream.

According to an embodiment of the present disclosure, the prediction encoder 3410 may generate residual data corresponding to a difference between the prediction block and the current block. When the prediction block is determined to be the current block, no residual data may be generated.

The generator 3420 may generate a bitstream including a result of encoding an image. The bitstream may include a result of encoding the current block.

According to an embodiment of the present disclosure, when the prediction mode of the current block is the block copy mode, the generator 3420 may generate a bitstream including the information about the block vector indicating the reference block.

According to an embodiment of the present disclosure, the generator 3420 may transmit the bitstream to the image decoding apparatus 2000 over a network.

According to an embodiment of the present disclosure, the generator 3420 may store the bitstream in a data storage medium including at least one of a magnetic medium such as a hard disk, a floppy disk, and a magnetic tape, an optical recording medium such as a compact disk read-only memory (CD-ROM) and a digital versatile disk (DVD), or a magneto-optical medium such as a floptical disk.

The generator 3420 may generate a bitstream including syntax elements generated through encoding of an image. Values corresponding to the syntax elements may be included in the bitstream according to a hierarchical structure of an image.

The generator 3420 may obtain bins included in the bitstream by entropy encoding the syntax elements.

According to an embodiment of the present disclosure, the bitstream may include information about the prediction mode of the current block in a current image.

According to an embodiment of the present disclosure, when the prediction mode of the current block is the intra mode, the bitstream may include information indicating intra prediction mode of the current block.

In the intra mode, a prediction block of the current block may be generated based on neighboring samples of the current block according to intra prediction mode, assuming that there is a continuity between the neighboring samples of the current block and samples in the current block. The prediction encoder 3410 according to an embodiment of the present disclosure may use not only the neighboring samples of the current block included in the current image, but also a spatial reference sample included in the current image for intra prediction. When a sample reconstructed before the current block is used, not only samples directly adjacent to the current block, but also samples far from the current block may be used to predict the samples of the current block, and thus, a size of residual data may be reduced. According to an embodiment of the present disclosure, the image encoding apparatus 3400 may perform intra prediction using the reference block including a sample not reconstructed, and thus, a range of an area which may be determined as the reference block may be increased. The image encoding apparatus 3400 according to an embodiment of the present disclosure may increase intra prediction efficiency, thereby improving the compression efficiency.

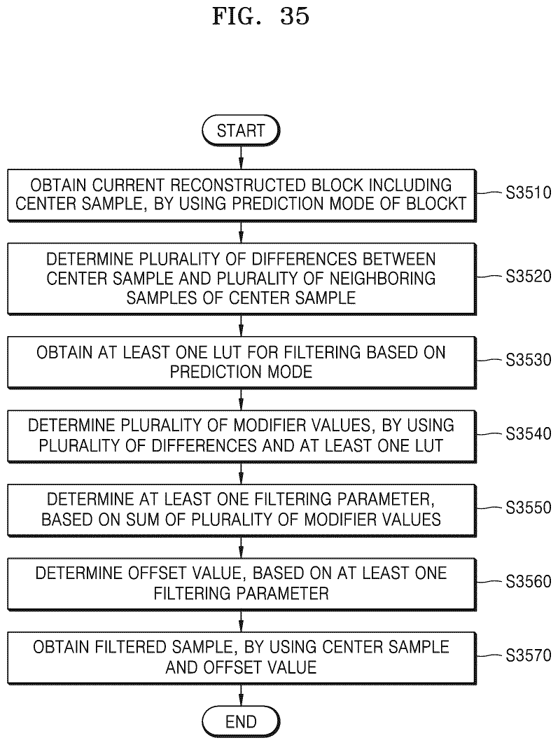

FIG. 35 is a flowchart illustrating an image encoding method according to an embodiment of the present disclosure.

Referring to FIG. 35, in operation S3510, the image encoding apparatus 3400 may obtain a current reconstructed block including a center sample by using a prediction mode of a block. According to an embodiment of the present disclosure, the current reconstructed block may include a block on which deblocking filtering has been performed.

In operation S3520, the image encoding apparatus 3400 may determine a plurality of differences between the center sample and a plurality of neighboring samples of the center sample. For example, the image encoding apparatus 3400 may determine a difference between the center sample and each of the neighboring samples. According to an embodiment of the present disclosure, the image encoding apparatus 3400 may determine a rounded difference between the center sample and the neighboring sample.

In operation S3530, the image encoding apparatus 3400 may obtain at least one LUT for filtering based on a prediction mode. According to an embodiment of the present disclosure, the image encoding apparatus 3400 may obtain at least one of a plurality of LUTs according to the prediction mode. For example, the image encoding apparatus 3400 may obtain a LUT corresponding to an IBC mode from among the plurality of LUTs based on the prediction mode being the IBC mode.

In operation S3540, the image encoding apparatus 3400 may determine a plurality of modifier values by using the plurality of differences and the at least one LUT. According to an embodiment of the present disclosure, the image encoding apparatus 3400 may obtain a modifier value of a LUT corresponding to each difference. For example, the image encoding apparatus 3400 may determine the difference as an index value of the LUT, and obtain an output value of the LUT corresponding to the index value as the modifier value.

In operation S3550, the image encoding apparatus 3400 may determine at least one filtering parameter based on the sum of the plurality of modifier values. According to an embodiment of the present disclosure, the number of filtering parameters may be determined according to the prediction mode.

In operation S3560, the image encoding apparatus 3400 may determine an offset value based on the at least one filtering parameter. According to an embodiment of the present disclosure, the greater the filtering parameter, the greater the offset value. According to an embodiment of the present disclosure, the offset value may include a change amount of the current sample value according to filtering.

In operation S3570, the image encoding apparatus 3400 may obtain a filtered sample by using the center sample and the offset value. According to an embodiment of the present disclosure, the image encoding apparatus 3400 may perform adaptive loop filtering using the filtered sample.

According to an embodiment of the present disclosure, an image decoding method is provided. The image decoding method may include obtaining a current reconstructed block including a center sample, by using a prediction mode of a block. The image decoding method may include determining a plurality of differences between the center sample and a plurality of neighboring samples of the center sample. The image decoding method may include obtaining at least one LUT for filtering based on the prediction mode. The image decoding method may include determining a plurality of modifier values, by using the plurality of differences and the at least one LUT. The image decoding method may include determining at least one filtering parameter, based on a sum of the plurality of modifier values. The image decoding method may include determining an offset value, based on the at least one filtering parameter. The image decoding method may include obtaining a filtered sample, by using the center sample and the offset value.

According to an embodiment of the present disclosure, the determining of the at least one filtering parameter may include determining a multiplier value, based on at least one of the prediction mode, a width of a transform block including the center sample, or a height of the transform block. The determining of the at least one filtering parameter may include determining the at least one filtering parameter, by using the multiplier value and the sum of the plurality of modifier values.

According to an embodiment of the present disclosure, when the prediction mode indicates a CIIP mode or a GPM, the at least one LUT may include at least one of an inter LUT corresponding to an inter prediction mode, an intra LUT corresponding to an intra prediction mode, or a LUT predetermined according to the prediction mode.

According to an embodiment of the present disclosure, when the LUT includes the inter LUT and the intra LUT, the determining of the plurality of modifier values may include determining a plurality of inter modifier values, by using the plurality of differences and the inter LUT. The determining of the plurality of modifier values may include determining a plurality of intra modifier values, by using the plurality of differences and the intra LUT.

The obtaining of the at least one filtering parameter may include obtaining an inter filtering parameter, based on a sum of the plurality of inter modifier values. The obtaining of the at least one filtering parameter may include obtaining an intra filtering parameter, based on a sum of the plurality of intra modifier values. The determining of the offset value may include determining the offset value, based on the inter filtering parameter and the intra filtering parameter.

According to an embodiment of the present disclosure, when the prediction mode indicates an IBC mode or an intra template matching prediction mode, the at least one LUT may include at least one of a LUT used for filtering a reference block corresponding to the block or the LUT predetermined according to the prediction mode.

According to an embodiment of the present disclosure, the image decoding method may include obtaining, from a bitstream, index information indicating a type of the LUT. The image decoding method may include determining the LUT, based on the index information.

According to an embodiment of the present disclosure, the determining of the plurality of differences may include performing deblocking filtering on the current reconstructed block. The determining of the plurality of differences may include obtaining the plurality of differences between the deblocking filtered center sample and the plurality of deblocking filtered neighboring samples. The image decoding method may include performing adaptive loop filtering on a filtered sample.

According to an embodiment of the present disclosure, when the center sample indicates a luma center sample of the luma component, the image decoding method may include determining a chroma LUT of a chroma component, by using the luma center sample and a plurality of neighboring samples of the luma center sample. The image decoding method may include obtaining a chroma filtering parameter, based on the chroma LUT of the chroma component. The image decoding method may include obtaining a filtered chroma sample, based on the chroma filtering parameter.

According to an embodiment of the present disclosure, when the center sample indicates a luma center sample of a luma component, the image decoding method may include determining a chroma LUT of a chroma component, based on at least one of the offset value or the filtered sample. The image decoding method may include obtaining a chroma filtering parameter, based on the chroma LUT of the chroma component. The image decoding method may include obtaining a filtered chroma sample, based on the chroma filtering parameter.

According to an embodiment of the present disclosure, when the center sample indicates a first chroma center sample of a first chroma component, the image decoding method may include determining a chroma LUT of a second chroma component, by using the first chroma center sample and a plurality of neighboring samples of the first chroma center sample. The image decoding method may include obtaining a chroma filtering parameter, based on the chroma LUT of the second chroma component. The image decoding method may include obtaining a filtered chroma sample corresponding to the sample of the second chroma component, based on the chroma filtering parameter.

According to an embodiment of the present disclosure, an image encoding method is provided. The image encoding method may include obtaining a current reconstructed block including a center sample, by using a prediction mode of a block. The image encoding method may include determining a plurality of differences between the center sample and a plurality of neighboring samples of the center sample. The image encoding method may include obtaining at least one LUT for filtering based on the prediction mode. The image encoding method may include determining a plurality of modifier values, by using the plurality of differences and the at least one LUT. The image encoding method may include determining at least one filtering parameter, based on a sum of the plurality of modifier values. The image encoding method may include determining an offset value, based on the at least one filtering parameter. The image encoding method may include obtaining a filtered sample, by using the center sample and the offset value.

According to an embodiment of the present disclosure, the determining of the at least one filtering parameter may include determining a multiplier value, based on at least one of the prediction mode, a width of a transform block including the center sample, or a height of the transform block. The determining of the at least one filtering parameter may include determining the at least one filtering parameter, by using the multiplier value and the sum of the plurality of modifier values.

According to an embodiment of the present disclosure, when the prediction mode indicates a CIIP mode or a GPM, the at least one LUT may include at least one of an inter LUT corresponding to an inter prediction mode, an intra LUT corresponding to an intra prediction mode, or a LUT predetermined according to the prediction mode.

According to an embodiment of the present disclosure, when the LUT includes the inter LUT and the intra LUT, the determining of the plurality of modifier values may include determining a plurality of inter modifier values, by using the plurality of differences and the inter LUT. The determining of the plurality of modifier values may include determining a plurality of intra modifier values, by using the plurality of differences and the intra LUT.

The obtaining of the at least one filtering parameter may include obtaining an inter filtering parameter, based on a sum of the plurality of inter modifier values. The obtaining of the at least one filtering parameter may include obtaining an intra filtering parameter, based on a sum of the plurality of intra modifier values. The determining of the offset value may include determining the offset value, based on the inter filtering parameter and the intra filtering parameter.

According to an embodiment of the present disclosure, when the prediction mode indicates an IBC mode or an intra template matching prediction mode, the at least one LUT may include at least one of a LUT used for filtering a reference block corresponding to the block or the LUT predetermined according to the prediction mode.

According to an embodiment of the present disclosure, the image encoding method may include obtaining, from a bitstream, index information indicating a type of the LUT. The image encoding method may include determining the LUT, based on the index information.

According to an embodiment of the present disclosure, the determining of the plurality of differences may include performing deblocking filtering on the current reconstructed block. The determining of the plurality of differences may include obtaining the plurality of differences between the deblocking filtered center sample and the plurality of deblocking filtered neighboring samples. The image encoding method may include performing adaptive loop filtering on a filtered sample.

According to an embodiment of the present disclosure, when the center sample indicates a luma center sample of the luma component, the image encoding method may include determining a chroma LUT of a chroma component, by using the luma center sample and a plurality of neighboring samples of the luma center sample. The image encoding method may include obtaining a chroma filtering parameter, based on the chroma LUT of the chroma component. The image encoding method may include obtaining a filtered chroma sample, based on the chroma filtering parameter.

According to an embodiment of the present disclosure, when the center sample indicates a luma center sample of a luma component, the image encoding method may include determining a chroma LUT of a chroma component, based on at least one of the offset value or the filtered sample. The image encoding method may include obtaining a chroma filtering parameter, based on the chroma LUT of the chroma component. The image encoding method may include obtaining a filtered chroma sample, based on the chroma filtering parameter.

According to an embodiment of the present disclosure, when the center sample indicates a first chroma center sample of a first chroma component, the image encoding method may include determining a chroma LUT of a second chroma component, by using the first chroma center sample and a plurality of neighboring samples of the first chroma center sample. The image encoding method may include obtaining a chroma filtering parameter, based on the chroma LUT of the second chroma component. The image encoding method may include obtaining a filtered chroma sample corresponding to the sample of the second chroma component, based on the chroma filtering parameter.

According to an embodiment of the present disclosure, a computer-readable storage medium having stored therein at least one of a bitstream encoded by the image encoding method or a bitstream decoded by an image decoding apparatus is provided.

According to an embodiment of the present disclosure, an image decoding apparatus is provided. The image decoding apparatus may include at least one processor and memory. The at least one processor may execute one or more instructions included in the memory to obtain a current reconstructed block including a center sample, by using a prediction mode of a block. The at least one processor may determine a plurality of differences between the center sample and a plurality of neighboring samples of the center sample. The at least one processor may obtain at least one LUT for filtering based on the prediction mode. The at least one processor may determine a plurality of modifier values, by using the plurality of differences and the at least one LUT. The at least one processor may determine at least one filtering parameter, based on a sum of the plurality of modifier values. The at least one processor may determine an offset value, based on the at least one filtering parameter. The at least one processor may obtain a filtered sample, by using the center sample and the offset value.

According to an embodiment of the present disclosure, the at least one processor may determine a multiplier value, based on at least one of the prediction mode, a width of a transform block including the center sample, or a height of the transform block. The at least one processor may determine the at least one filtering parameter, by using the multiplier value and the sum of the plurality of modifier values.

According to an embodiment of the present disclosure, when the prediction mode indicates a CIIP mode or a GPM, the at least one LUT may include at least one of an inter LUT corresponding to an inter prediction mode, an intra LUT corresponding to an intra prediction mode, or a LUT predetermined according to the prediction mode.

According to an embodiment of the present disclosure, when the LUT includes the inter LUT and the intra LUT, the at least one processor may determine a plurality of inter modifier values, by using the plurality of differences and the inter LUT. The at least one processor may determine a plurality of intra modifier values, by using the plurality of differences and the intra LUT.

The at least one processor may obtain an inter filtering parameter, based on a sum of the plurality of inter modifier values. The at least one processor may obtain an intra filtering parameter, based on a sum of the plurality of intra modifier values. The at least one processor may determine the offset value, based on the inter filtering parameter and the intra filtering parameter.

According to an embodiment of the present disclosure, when the prediction mode indicates an IBC mode or an intra template matching prediction mode, the at least one LUT may include at least one of a LUT used for filtering a reference block corresponding to the block or the LUT predetermined according to the prediction mode.

According to an embodiment of the present disclosure, the at least one processor may obtain, from a bitstream, index information indicating a type of the LUT. The at least one processor may determine the LUT, based on the index information.

According to an embodiment of the present disclosure, the at least one processor may perform deblocking filtering on the current reconstructed block. The at least one processor may obtain the plurality of differences between the deblocking filtered center sample and the plurality of deblocking filtered neighboring samples. The at least one processor may perform adaptive loop filtering on a filtered sample.

According to an embodiment of the present disclosure, when the center sample indicates a luma center sample of the luma component, the least one processor may determine a chroma LUT of a chroma component, by using the luma center sample and a plurality of neighboring samples of the luma center sample. The at least one processor may obtain a chroma filtering parameter, based on the chroma LUT of the chroma component. The at least one processor may obtain a filtered chroma sample, based on the chroma filtering parameter.

According to an embodiment of the present disclosure, when the center sample indicates a luma center sample of a luma component, the at least one processor may determine a chroma LUT of a chroma component, based on at least one of the offset value or the filtered sample. The at least one processor may obtain a chroma filtering parameter, based on the chroma LUT of the chroma component. The at least one processor may obtain a filtered chroma sample, based on the chroma filtering parameter.

According to an embodiment of the present disclosure, when the center sample indicates a first chroma center sample of a first chroma component, the at least one processor may determine a chroma LUT of a second chroma component, by using the first chroma center sample and a plurality of neighboring samples of the first chroma center sample. The at least one processor may obtain a chroma filtering parameter, based on the chroma LUT of the second chroma component. The at least one processor may obtain a filtered chroma sample corresponding to the sample of the second chroma component, based on the chroma filtering parameter.

According to an embodiment of the present disclosure, an image encoding apparatus is provided. The image encoding apparatus may include at least one processor and memory. The at least one processor may execute one or more instructions included in the memory to obtain a current reconstructed block including a center sample, by using a prediction mode of a block. The at least one processor may determine a plurality of differences between the center sample and a plurality of neighboring samples of the center sample. The at least one processor may obtain at least one LUT for filtering based on the prediction mode. The at least one processor may determine a plurality of modifier values, by using the plurality of differences and the at least one LUT. The at least one processor may determine at least one filtering parameter, based on a sum of the plurality of modifier values. The at least one processor may determine an offset value, based on the at least one filtering parameter. The at least one processor may obtain a filtered sample, by using the center sample and the offset value.

According to an embodiment of the present disclosure, the at least one processor may determine a multiplier value, based on at least one of the prediction mode, a width of a transform block including the center sample, or a height of the transform block. The at least one processor may determine the at least one filtering parameter, by using the multiplier value and the sum of the plurality of modifier values.

According to an embodiment of the present disclosure, when the prediction mode indicates a CIIP mode or a GPM, the at least one LUT may include at least one of an inter LUT corresponding to an inter prediction mode, an intra LUT corresponding to an intra prediction mode, or a LUT predetermined according to the prediction mode.

According to an embodiment of the present disclosure, when the LUT includes the inter LUT and the intra LUT, the at least one processor may determine a plurality of inter modifier values, by using the plurality of differences and the inter LUT. The at least one processor may determine a plurality of intra modifier values, by using the plurality of differences and the intra LUT.

The at least one processor may obtain an inter filtering parameter, based on a sum of the plurality of inter modifier values. The at least one processor may obtain an intra filtering parameter, based on a sum of the plurality of intra modifier values. The at least one processor may determine the offset value, based on the inter filtering parameter and the intra filtering parameter.

According to an embodiment of the present disclosure, when the prediction mode indicates an IBC mode or an intra template matching prediction mode, the at least one LUT may include at least one of a LUT used for filtering a reference block corresponding to the block or the LUT predetermined according to the prediction mode.

According to an embodiment of the present disclosure, the at least one processor may obtain, from a bitstream, index information indicating a type of the LUT. The at least one processor may determine the LUT, based on the index information.

According to an embodiment of the present disclosure, the at least one processor may perform deblocking filtering on the current reconstructed block. The at least one processor may obtain the plurality of differences between the deblocking filtered center sample and the plurality of deblocking filtered neighboring samples. The at least one processor may perform adaptive loop filtering on a filtered sample.

According to an embodiment of the present disclosure, when the center sample indicates a luma center sample of the luma component, the least one processor may determine a chroma LUT of a chroma component, by using the luma center sample and a plurality of neighboring samples of the luma center sample. The at least one processor may obtain a chroma filtering parameter, based on the chroma LUT of the chroma component. The at least one processor may obtain a filtered chroma sample, based on the chroma filtering parameter.

According to an embodiment of the present disclosure, when the center sample indicates a luma center sample of a luma component, the at least one processor may determine a chroma LUT of a chroma component, based on at least one of the offset value or the filtered sample. The at least one processor may obtain a chroma filtering parameter, based on the chroma LUT of the chroma component. The at least one processor may obtain a filtered chroma sample, based on the chroma filtering parameter.

According to an embodiment of the present disclosure, when the center sample indicates a first chroma center sample of a first chroma component, the at least one processor may determine a chroma LUT of a second chroma component, by using the first chroma center sample and a plurality of neighboring samples of the first chroma center sample. The at least one processor may obtain a chroma filtering parameter, based on the chroma LUT of the second chroma component. The at least one processor may obtain a filtered chroma sample corresponding to the sample of the second chroma component, based on the chroma filtering parameter.

An image decoding method, an image decoding apparatus, an image encoding method, and an image encoding apparatus according to an embodiment of the present disclosure may determine filtering parameters corresponding to more detailed prediction modes than the inter prediction mode and the intra prediction mode, which improves the performance of filtering, thereby improving the quality of the reconstructed image. However, the technical effects of the image decoding method according to an embodiment of the present disclosure are not limited to the described aspects and may include technical features generated according to the present disclosure.

An image decoding method, an image decoding apparatus, an image encoding method, and an image encoding apparatus according to an embodiment of the present disclosure may determine a filtering parameter with respect to a chroma sample by using information about a sample other than a filtering target, which improves the performance of filtering, thereby improving the quality of the reconstructed image. However, the technical effects of the image decoding method according to an embodiment of the present disclosure are not limited to the described aspects and may include technical features generated according to the present disclosure.

The machine-readable storage medium may be provided in the shape of a non-transitory storage medium. Here, the ‘non-transitory storage medium’ only denotes a tangible device and does not include a signal (e.g., electromagnetic waves). This term does not distinguish a case where data is stored in the storage medium semi-permanently and a case where the data is stored in the storage medium temporarily. For example, the ‘non-transitory storage medium’ may include a buffer where data is temporarily store.

According to an embodiment, a method according to various embodiments of the disclosure in the specification may be provided by being included in a computer program product. The computer program product, which is a commodity, may be traded between sellers and buyers. The computer program product may be distributed in the shape of machine-readable storage medium (e.g., compact disc read only memory (CD-ROM)), or distributed (e.g., downloaded or uploaded) through an application store or directly and online between two user devices (e.g., smartphones). In the case of online distribution, at least a part of the computer program product (e.g., a downloadable app) may be at least temporarily generated or temporarily stored in a machine-readable storage medium, such as a server of a manufacturer, a server of an application store, or memory of a relay server.

What is claimed is:

1. An image decoding method comprising:
obtaining a current reconstructed block comprising a center sample, by using a prediction mode of a block;
determining a plurality of differences between the center sample and a plurality of neighboring samples of the center sample;
obtaining at least one lookup table (LUT) for filtering based on the prediction mode;
determining a plurality of modifier values, based on the plurality of differences and the at least one LUT;
determining at least one filtering parameter, based on a sum of the plurality of modifier values;
determining an offset value, based on the at least one filtering parameter; and
obtaining a filtered sample, based on the center sample and the offset value.

2. The image decoding method of claim 1, wherein the determining the at least one filtering parameter comprises:
determining a multiplier value, based on at least one of the prediction mode, a width of a transform block including the center sample, or a height of the transform block; and
determining the at least one filtering parameter, based on the multiplier value and the sum of the plurality of modifier values.

3. The image decoding method of claim 1, wherein based on the prediction mode indicating a combined inter and intra prediction mode (CIIP) mode or a geometric partition mode (GPM), the at least one LUT comprises at least one of an inter LUT corresponding to an inter prediction mode, an intra LUT corresponding to an intra prediction mode, or a LUT predetermined according to the prediction mode.

4. The image decoding method of claim 3, wherein the determining the plurality of modifier values comprises, based on the LUT comprising the inter LUT and the intra LUT:
determining a plurality of inter modifier values, based on the plurality of differences and the inter LUT; and
determining a plurality of intra modifier values, based on the plurality of differences and the intra LUT,
wherein the obtaining the at least one filtering parameter comprises:
obtaining an inter filtering parameter, based on a sum of the plurality of inter modifier values; and
obtaining an intra filtering parameter, based on a sum of the plurality of intra modifier values, and
wherein the determining the offset value comprises determining the offset value, based on the inter filtering parameter and the intra filtering parameter.

5. The image decoding method of claim 1, wherein, based on the prediction mode indicating an intra block copy (IBC) mode or an intra template matching prediction mode, the at least one LUT comprises at least one of a LUT used for filtering a reference block corresponding to the block or the LUT predetermined according to the prediction mode.

6. The image decoding method of claim 1, further comprising:
obtaining, from a bitstream, index information indicating a type of the LUT; and
determining the LUT, based on the index information.

7. The image decoding method of claim 1, wherein the determining the plurality of differences includes
performing deblocking filtering on the current reconstructed block; and
obtaining the plurality of differences between the deblocking filtered center sample and the plurality of deblocking filtered neighboring samples, and
wherein the image decoding method further comprises performing adaptive loop filtering on the filtered sample.

8. The image decoding method of claim 1, further comprising:
based on the center sample indicating a luma center sample of the luma component, determining a chroma LUT of a chroma component, based on the luma center sample and a plurality of neighboring samples of the luma center sample;
obtaining a chroma filtering parameter, based on the chroma LUT of the chroma component; and
obtaining a filtered chroma sample, based on the chroma filtering parameter.

9. The image decoding method of claim 1, further comprising:
based on the center sample indicating a luma center sample of a luma component, determining a chroma LUT of a chroma component, based on at least one of the offset value or the filtered sample;
obtaining a chroma filtering parameter, based on the chroma LUT of the chroma component; and
obtaining a filtered chroma sample, based on the chroma filtering parameter.

10. The image decoding method of claim 1, further comprising:
based on the center sample indicates a first chroma center sample of a first chroma component, determining a chroma LUT of a second chroma component, based on the first chroma center sample and a plurality of neighboring samples of the first chroma center sample;
obtaining a chroma filtering parameter, based on the chroma LUT of the second chroma component; and
obtaining a filtered chroma sample corresponding to a sample of the second chroma component, based on the chroma filtering parameter.

11. An image encoding method comprising:
obtaining a current reconstructed block comprising a center sample, by using a prediction mode of a block;
determining a plurality of differences between the center sample and a plurality of neighboring samples of the center sample;
obtaining at least one lookup table (LUT) for filtering based on the prediction mode;
determining a plurality of modifier values, based on the plurality of differences and the at least one LUT;
determining at least one filtering parameter, based on a sum of the plurality of modifier values;
determining an offset value, based on the at least one filtering parameter; and
obtaining a filtered sample, based on the center sample and the offset value.

12. The image encoding method of claim 11, wherein the determining the at least one filtering parameter comprises:
determining a multiplier value, based on at least one of the prediction mode, a width of a transform block including the center sample, or a height of the transform block; and
determining the at least one filtering parameter, based on the multiplier value and the sum of the plurality of modifier values.

13. The image encoding method of claim 11, wherein, based on the prediction mode indicating a combined inter and intra prediction mode (CIIP) mode or a geometric partition mode (GPM), the at least one LUT comprises at least one of an inter LUT corresponding to an inter prediction mode, an intra LUT corresponding to an intra prediction mode, or a LUT predetermined according to the prediction mode.

14. The image encoding method of claim 13, wherein the determining the plurality of modifier values comprises, based on the LUT comprising the inter LUT and the intra LUT:
determining a plurality of inter modifier values, based on the plurality of differences and the inter LUT; and
determining a plurality of intra modifier values, based on the plurality of differences and the intra LUT,
wherein the obtaining the at least one filtering parameter comprises:
obtaining an inter filtering parameter, based on a sum of the plurality of inter modifier values; and
obtaining an intra filtering parameter, based on a sum of the plurality of intra modifier values, and
wherein the determining the offset value comprises determining the offset value, based on the inter filtering parameter and the intra filtering parameter.

15. The image encoding method of claim 11, wherein, based on the prediction mode indicating an intra block copy (IBC) mode or an intra template matching prediction mode, the at least one LUT comprises at least one of a LUT used for filtering a reference block corresponding to the block or the LUT predetermined according to the prediction mode.

16. The image encoding method of claim 11, further comprising:
obtaining, from a bitstream, index information indicating a type of the LUT; and
determining the LUT, based on the index information.

17. The image encoding method of claim 11, wherein the determining the plurality of differences comprises:
performing deblocking filtering on the current reconstructed block; and
obtaining the plurality of differences between the deblocking filtered center sample and the plurality of deblocking filtered neighboring samples, and
wherein the image encoding method further comprises performing adaptive loop filtering on a filtered sample.

18. The image encoding method of claim 11, further comprising:
based on the center sample indicating a luma center sample of the luma component, determining a chroma LUT of a chroma component, based on the luma center sample and a plurality of neighboring samples of the luma center sample;
obtaining a chroma filtering parameter, based on the chroma LUT of the chroma component; and
obtaining a filtered chroma sample, based on the chroma filtering parameter.

19. The image encoding method of claim 11, further comprising:
based on the center sample indicating a luma center sample of a luma component, determining a chroma LUT of a chroma component, based on at least one of the offset value or the filtered sample;
obtaining a chroma filtering parameter, based on the chroma LUT of the chroma component; and
obtaining a filtered chroma sample, based on the chroma filtering parameter.

20. A non-transitory computer-readable storage medium having stored thereon a bitstream encoded by an image encoding method comprising:
obtaining a current reconstructed block comprising a center sample, by using a prediction mode of a block;
determining a plurality of differences between the center sample and a plurality of neighboring samples of the center sample;
obtaining at least one lookup table (LUT) for filtering based on the prediction mode;
determining a plurality of modifier values, based on the plurality of differences and the at least one LUT;
determining at least one filtering parameter, based on a sum of the plurality of modifier values;
determining an offset value, based on the at least one filtering parameter; and
obtaining a filtered sample, based on the center sample and the offset value.
